(19) United States
(12) Patent Application Publication
(10) Pub. No.: US 2024/0269909 A1
(43) Pub. Date: Aug. 15, 2024

(54) EXTRUDER MIXER, EXTRUDER MIXING SECTION, EXTRUDER SYSTEM AND METHODS OF USE THEREOF FOR MIXING OF POLYMERS

(71) Applicant: Randcastle Extrusion Systems, Inc., Cedar Grove, NJ (US)

(72) Inventor: Keith Luker, Cedar Grove, NJ (US)

(73) Assignee: Randcastle Extrusion Systems, Inc., Cedar Grove, NJ (US)

(21) Appl. No.: 18/568,024

(22) PCT Filed: Jun. 10, 2022
(86) PCT No.: PCT/US2022/032998

§ 371 Date: Dec. 7, 2023

Related U.S. Application Data
(60) Provisional application No. 63/209,591, filed on Jun. 11, 2021.

(51) Int. Cl. B29C 48/255; B29C 48/515; B29C 48/66; B29C 48/68; B29C 48/76

(52) U.S. Cl. CPC B29C 48/2552; B29C 48/515; B29C 48/66; B29C 48/68; B29C 48/766

(57) ABSTRACT

An extruder mixer and extruder mixer section are provided. The extruder mixer section includes inlet and outlet channels and an intermediate channel separated by pumps and bound by a flight portion. Also provided are methods of mixing polymers with the extruder mixer section. An extrusion system using the extruder mixer section is also provided.

### CROSS REFERENCE TO RELATED APPLICATIONS

This application claims the benefit of priority to U.S. provisional Application No. 63/209,591, filed on Jun. 11, 2021, the contents of which is incorporated herein by reference in its entirety for all purposes.

### FIELD OF THE INVENTION

The present invention relates to extruders, extruder mixer sections and use thereof to mix polymers.

### BACKGROUND OF THE INVENTION

U.S. Pat. No. 6,962,431 B1 discloses an extruder mixer and method for mixing plastic materials utilizing an elongated screw having an inlet channel connected to a first cross-axial pump that feeds, at an angle to the screw axis, a subsequent channel, wherein the subsequent channel becomes a further inlet channel connected to at least one subsequent cross-axial pump, and wherein the cross-axial pump is bounded by a flight on at least one side.

Despite such prior improvements in extruder mixers and methods for mixing, there remains a need for further improvements in terms of at least one of performance, properties of extrudate, and efficiency of use.

### SUMMARY OF THE INVENTION

An extruder mixer positioned about a central axis of an elongated rotatable screw, is provided. The extruder mixer comprises at least one mixing section between upstream 10 and downstream ends of the elongated rotatable screw. Each of the at least one mixing section has:
an inlet channel oriented in a direction angled relative to the central axis of the elongated rotatable screw, the inlet channel having an upstream opening, a downstream end, and a downstream side,
an intermediate channel circumferentially spaced from the inlet channel and oriented along the direction of the inlet channel, the intermediate channel having an upstream side, a downstream end, and a downstream side,
an outlet channel circumferentially spaced from the intermediate channel and oriented along the direction of the inlet channel, the outlet channel having an upstream side, a downstream side, and a downstream opening,
a first pump interposed between the downstream side of the inlet channel and the upstream side of the intermediate channel,
a second pump interposed between the downstream side of the intermediate channel and the upstream side of the outlet channel, and
a downstream flight portion positioned along the outlet channel.

The inlet channel, the intermediate channel, the output channel, the first pump, the second pump, and the downstream flight portion are arranged as follows. The inlet channel is bound at the downstream side by the first pump. The first pump is bound at the upstream side by the inlet channel, and at the downstream side by the intermediate channel. The intermediate channel is bound at the upstream side by the first pump, and at the downstream side by the second pump. The second pump is bound at the upstream side by the intermediate channel and at a downstream side by the outlet channel. The outlet channel is open at the downstream end and bound at a downstream side by the downstream flight portion and at the upstream side by the second pump. A height of the downstream flight portion is greater than heights of the first pump and the second pump in a direction radially outward from the central axis of the elongated rotational screw.

A method for mixing at least one polymer in an extruder system having an extruder barrel having a bore extending along a central axis is provided. The method comprises the following steps.

First, feeding the at least one polymer into the bore of the extruder barrel from a polymer feeder 38. Then, rotating an extruder screw extending within the bore of the extruder barrel about the central axis of the extruder barrel. Next, mixing the at least one polymer fed into the bore of the extruder barrel by flowing the at least one polymer into an inlet channel of a mixing section of the extruder screw in a direction angled relative to the central axis of the extruder screw from an upstream opening of the inlet channel to a downstream side of the inlet channel. After that, pumping the at least one polymer from the downstream side of the inlet channel to an upstream side of an intermediate channel using a first pump. Next, flowing the at least one polymer from the upstream side of the intermediate channel to a downstream side of the intermediate channel. Then pumping the at least one polymer from the downstream side of the intermediate channel to an upstream side of an outlet channel using a second pump. After that, flowing the at least one polymer from the upstream side of the outlet channel to a downstream opening of the outlet channel. Then, guiding the at least one polymer along the outlet channel using a downstream flight portion to thereby produce an extruded mixture of the at least one polymer.

A method for reducing hygroscopic properties of a hygroscopic polymer in an extruder system 5000 having an extruder barrel with a bore extending along a central axis is provided. The method comprises the following steps. First, drying wet hygroscopic polymer to produce a dried hygroscopic polymer. Then feeding the dried hygroscopic polymer into the bore of the extruder barrel from a polymer feeder. Next, rotating an extruder screw extending within the bore of the extruder barrel about the central axis of the extruder barrel. Then, mixing the dried hygroscopic polymer fed into the bore of the extruder barrel by first, flowing the polymer into an inlet channel of a mixing section of the extruder screw in a direction angled relative to the central axis of the extruder screw from an upstream opening of the inlet channel to a downstream side of the inlet channel. After that, pumping the polymer from the downstream side of the inlet channel to an upstream side of an intermediate channel using a first pump. Then, flowing the polymer from the upstream side of the intermediate channel to a downstream side of the intermediate channel. Next, pumping the polymer from the downstream side of the intermediate channel to an upstream side of an outlet channel using a second pump. After that, flowing the polymer from the upstream side of the outlet channel to a downstream opening of the outlet channel. Then guiding the polymer along the outlet channel using a downstream flight portion. Thus, producing an extruded polymer having reduced hygroscopic properties as compared to the dried hygroscopic polymer such that a water absorption rate of the extruded polymer is less than a water absorption rate of the dried hygroscopic polymer.

Also provided is a method of inhibiting the formation of bubbles in extrudate of a hygroscopic polymer using an extruder system having an extruder barrel with a bore extending along a central axis. The method comprises the following steps. First, feeding wet hygroscopic polymer into the bore of the extruder barrel from a polymer feeder. Next, rotating an extruder screw extending within the bore of the extruder barrel about the central axis of the extruder barrel. Then, mixing the wet hygroscopic polymer fed into the bore of the extruder barrel by performing the following steps. First, flowing the polymer into an inlet channel of a mixing section of the extruder screw in a direction angled relative to the central axis of the extruder screw from an upstream opening of the inlet channel to a downstream side of the inlet channel. Next, pumping the polymer from the downstream side of the inlet channel to an upstream side of an intermediate channel using a first pump. Then, flowing the polymer from the upstream side of the intermediate channel to a downstream side of the intermediate channel. After that, pumping the polymer from the downstream side of the intermediate channel to an upstream side of an outlet channel using a second pump. Then, flowing the polymer from the upstream side of the outlet channel to a downstream opening of the outlet channel. After that, guiding the polymer along the outlet channel using a downstream flight portion, thus producing the substantially bubble-free extrudate and eliminating the need to dry the hygroscopic polymer prior to extrusion.

### BRIEF DESCRIPTION OF THE DRAWINGS

FIGS. 1A-1F show a side view, cross-sectional views, and a side view of a section of an embodiment of the invention;

FIG. 2 shows a side view of another embodiment of the invention;

FIGS. 3A-3C show a side view, and cross-sectional views of another embodiment of the invention;

FIG. 4 shows a view of an embodiment of the invention, illustrating its operation;

FIG. 5 shows a view of an embodiment of the invention, illustrating its operation;

FIGS. 6A and 6B show a side view, and a cross-sectional view of an embodiment of the invention, illustrating its operation;

FIG. 7 shows a view of an embodiment of the invention, illustrating its operation;

FIG. 8 shows a view of an embodiment of the invention, illustrating its operation;

FIG. 9 shows a cross-sectional view of an embodiment of the invention;

FIG. 10 shows a side cross-sectional view of an embodiment of the invention;

FIG. 11 shows a side cross-sectional view of an embodiment of the invention;

FIG. 12 shows a side cross-sectional view of an embodiment of the invention;

FIG. 13 shows a view of an embodiment of the invention, illustrating its operation;

FIG. 14 shows a cross-sectional view of an embodiment of the invention, illustrating its operation;

FIG. 15 shows a view of an embodiment of the invention, illustrating its operation;

FIG. 16 shows a cross-sectional view of an embodiment of the invention, illustrating its operation;

FIG. 17 shows a view of an embodiment of the invention, illustrating its operation;

FIG. 18 shows a cross-sectional view of an embodiment of the invention, illustrating its operation;

FIG. 19 shows a cross-sectional view of an embodiment of the invention, illustrating its operation;

FIG. 20 shows a cross-sectional view of an embodiment of the invention, illustrating its operation;

FIG. 21 shows a cross-sectional view of an embodiment of the invention, illustrating its operation;

FIG. 22 shows a cross-sectional view of an embodiment of the invention, illustrating its operation;

FIG. 23 shows a cross-sectional view of an embodiment of the invention, illustrating its operation;

FIG. 24 shows a cross-sectional view of an embodiment of the invention, illustrating its operation;

FIG. 25 is a flow chart showing a method of mixing a polymer according to an embodiment of the invention;

FIG. 26 is flow chart showing a method of changing the hygroscopic properties of a polymer according to an embodiment of the invention;

FIG. 27 is a flow chart showing a method of inhibiting the formation of bubbles in extrudate of a hygroscopic polymer according to an embodiment of the invention; and

FIGS. 28-41 are photographs showing results obtained in the Examples and in Comparative Examples.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

Twin screw extruders having co-rotating twin screws provide elongational mixing at the intersection of the two screws, where only a small percentage of the total flow resides. Although twin screws may be an acceptable alternative in some applications, some twin screw extruders have a number of deficiencies in terms of obtaining uniformly well-mixed polymers.

For example, twin screw extruders can be very disorderly mixers since they do not repeat the same mixing over and over. In addition, desirable stretching in the mixing of polymers in twin screw extruders can be limited to a small percentage of the total mass of polymer in the extruder that is located at the intersection of the two screws. This amount may be as little as 5% or lower of the mass each time the screws intersect. Thus mixing of all of the polymer mass may not be achieved in twin screw extruders.

Even if all of the material were to be stretched in a twin screw extruder, some material may be stretched more than other material. The stretching at the intersection of the two screws may therefore be very uneven. For example, the differential speed of an overflight region penetrating toward a smaller root of a mating screw may be quite large. Also, the intersection stretches the flow of polymer one dimensionally only. This may not be as effective for mixing as it could be, since may inadequately mix in the planar and out of plane directions.

According to exemplary embodiments of this invention, an extruder mixer section can provide more uniform, extremely small scale mixing in three dimensions, while not adding undue heat and excess shear to the polymers while mixing. The inventor has surprisingly found that a single screw having an extruder mixer section disclosed herein is capable of providing extremely uniform mixing on both a large and small scale in three dimensions, while avoiding undesirable excessive heat and high shear history to a plasticized flowable material (e.g. polymer) that is being mixed.

### Apparatus

Referring generally to the figures, the present invention provides an extruder mixer, an extruder mixer section, and an extruder system. As used herein, the terms “mixer section” and “mixer element” are interchangeable.

An extruder mixer positioned about a central axis 11 of an elongated rotatable screw 100, 200 is provided. The extruder mixer comprises at least one mixing section 1001, 1002, 1003, 400, 401 between upstream 10 and downstream 12 ends of the elongated rotatable screw 100. Each of the at least one mixing section 1001, 1002, 1003, 400, 401 has:
an inlet channel 14, 1401, 1402, 1403 oriented in a direction angled relative to the central axis 11 of the elongated rotatable screw 100, the inlet channel 14, 1401, 1402, 1403 having an upstream opening, a downstream end, and a downstream side,
an intermediate channel 18, 1801, 1802, 1803 circumferentially spaced from the inlet channel 14, 1401, 1402, 1403 and oriented along the direction of the inlet channel, the intermediate channel 18, 1801, 1802, 1803 having an upstream side, a downstream end, and a downstream side,
an outlet channel 16, 1601, 1602, 1603 circumferentially spaced from the intermediate channel 18, 1801, 1802, 1803 and oriented along the direction of the inlet channel, the outlet channel 16, 1601, 1602, 1603 having an upstream side, a downstream side, and a downstream opening,
a first pump 20, 2001, 2002, 2003 interposed between the downstream side of the inlet channel and the upstream side of the intermediate channel,
a second pump 22, 2201, 2202, 2203 interposed between the downstream side of the intermediate channel and the upstream side of the outlet channel, and
a downstream flight portion 24, 2401, 2402, 2403 positioned along the outlet channel 16, 1601, 1602, 1603.

The inlet channel 14, 1401, 1402, 1403, the intermediate 18, 1801, 1802, 1803 channel, the output channel 16, 1601, 1602, 1603, the first pump 20, 2001, 2002, 2003, the second pump 22, 2201, 2202, 2203, and the downstream flight portion 24, 2401, 2402, 2403 are arranged as follows. The inlet channel 14, 1401, 1402, 1403 is bound at the downstream side by the first pump 20, 2001, 2002, 2003. The first pump 20, 2001, 2002, 2003 is bound at the upstream side by the inlet channel 14, 1401, 1402, 1403, and at the downstream side by the intermediate channel 18, 1801, 1802, 1803. The intermediate channel 18, 1801, 1802, 1803 is bound at the upstream side by the first pump 20, 2001, 2002, 2003, and at the downstream side by the second pump 22, 2201, 2202, 2203. The second pump 22, 2201, 2202, 2203 is bound at the upstream side by the intermediate channel 18, 1801, 1802, 1803, and at a downstream side by the outlet channel 16, 1601, 1602, 1603. The outlet channel 16, 1601, 1602, 1603 is open at the downstream end and bound at a downstream side by the downstream flight portion 24, 2401, 2402, 2403 and at the upstream side by the second pump 22, 2201, 2202, 2203. A height of the downstream flight portion is greater than heights of the first pump and the second pump in a direction radially outward from the central axis of the elongated rotational screw.

The extruder mixer may further comprise a transverse flight portion 26, 2601, 2602, 2603 oriented transverse relative to the downstream flight portion 24, 2401, 2402, 2403. The transverse flight portion 26, 2601, 2602, 2603 may be positioned to terminate the downstream ends of the inlet channel and the intermediate channel. The inlet channel 14, 1401, 1402, 1403 may be bound at the downstream end by the transverse flight portion 26, 2601, 2602, 2603. The first pump 20, 2001, 2002, 2003 may be bound at the downstream end by the transverse flight portion 26, 2601, 2602, 2603. The intermediate channel 18, 1801, 1802, 1803 may be bound at the downstream end by the transverse flight portion 26, 2601, 2602, 2603. The second pump 22, 2201, 2202, 2203 may be bound at the downstream end by the transverse flight portion 26, 2601, 2602, 2603. Heights of the downstream flight portion and the transverse flight portion are greater than heights of the first pump and the second pump in a direction radially outward from the central axis of the elongated rotational screw.

The extruder mixer may comprise at least two mixing sections 1001, 1002, 1003, 400, 401, one of the at least two mixing sections 1001, 1002, 1003, 400, 401 being an upstream mixing section and another one of the mixing sections being a downstream mixing section. The downstream opening of the outlet channel 16, 1601, 1602, 1603 of the upstream mixing section 1001, 1002, 1003, 400, 401 is in flow communication with the upstream opening of the inlet channel 14, 1401, 1402, 1403 of the downstream mixing section.

The direction of the inlet channel 14, 1401, 1402, 1403 may be oriented at an angle of 30 to 60 degrees relative to the central axis 11 of the elongated rotational screw 100, 200. The direction of the inlet channel 14, 1401, 1402, 1403 may be oriented at an angle of 40 to 50 degrees relative to the central axis of the elongated rotational screw 100, 200. The first pump 20, 2001, 2002, 2003 may be arranged at an angle of 30 to 60 degrees relative to the direction of the inlet channel 14, 1401, 1402, 1403.

The extruder mixer may further comprise a fluid insertion aperture 30 located in the outlet channel 14, 1401, 1402, 1403. The fluid insertion aperture 30 may be configured and arranged to be in fluid connection with a fluid delivery passage 32 within the elongated rotatable screw 100, 200.

Also provided is an extruder screw 100, 200 comprising the extruder mixer 1001, 1002, 1003, 400, 401. The extruder screw 100, 200 may further comprise a flighted section 202 upstream of the at least one mixing section 1001, 1002, 1003, 400, 401. The flighted section 202 may be configured and arranged to control a flow of plasticized flowable material into the upstream opening of the inlet channel 14, 1401, 1402, 1403 of the at least one mixing section 1001, 1002, 1003, 400, 401. The extruder screw 100, 200 may further comprising a flighted section 202 between the upstream mixing section 1001, 1002, 1003, 400, 401 of the at least two mixing sections 1001, 1002, 1003, 400, 401 and the downstream mixing section 1001, 1002, 1003, 400, 401. The flighted section 202 may be configured and arranged to control a flow of plasticized flowable material into the upstream opening of the inlet channel 14, 1401, 1402, 1403 of the downstream mixing section 1001, 1002, 1003, 400, 401.

An extruder system 5000 is provided. The extruder system 5000 comprises an extruder barrel 34 having a bore 36 extending along a central axis 11. The extruder system also comprises a polymer feeder 38 associated with the extruder barrel 34 and the polymer feeder 38 is configured to feed polymer into the bore 36 of the extruder barrel 34. The extruder system 5000 comprises an elongated rotatable screw 100, 200 extending within the bore of the extruder barrel 34 and mounted for rotation about the central axis 11 of the extruder barrel 34. At least one extruder mixer 1001, 1002, 1003, 400, 401 is provided on the elongated rotatable screw 100, 200 and configured to mix the polymer fed into the bore 36 of the extruder barrel 34.

Referring now to specific embodiments shown in the figures for purposes of illustration, details of exemplary embodiments of an extruder mixer, an extruder mixer, and an extruder system will now be described. As is known in the art, the inventive extruder mixer section may be described herein conventionally, as if the barrel were moving around a stationary screw and using the flat plate model.

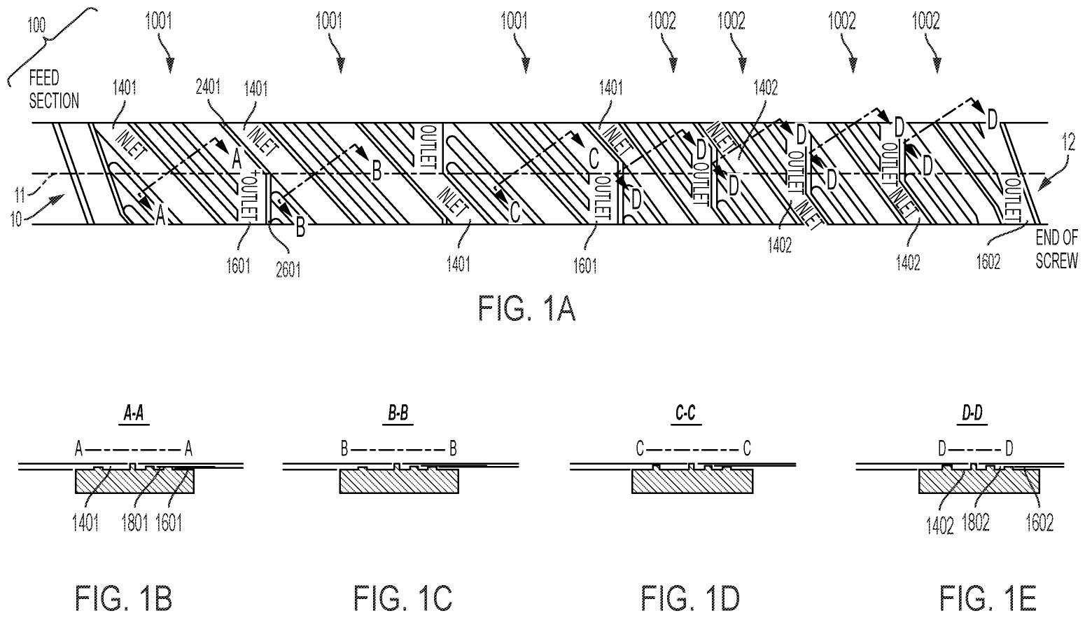

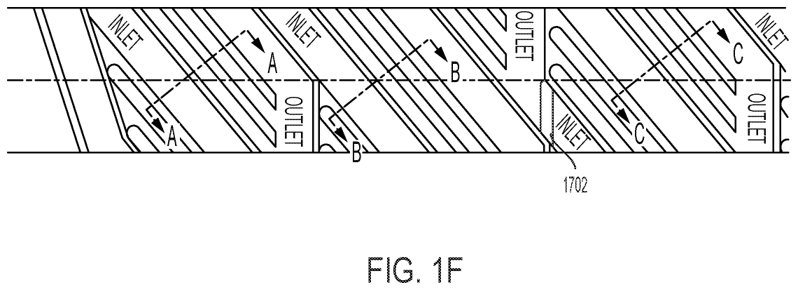

FIG. 1A shows a side view of an elongated rotatable extruder screw 100, the extruder screw 100 comprising three first embodiment extruder mixer sections 1001 and four second embodiment extruder mixer sections 1002 positioned about a central axis of the elongated rotatable screw 100. An elongated rotatable screw 100 may comprise one or more than one such extruder mixer sections 1001, 1002. If more than one such extruder mixer sections are present, they may be the same or different. They may be immediately next to each other along the extruder screw 100, as shown in FIG. 1A, or they may be separated by flighted sections. These flighted sections may be configured and arranged in order to restrict flow to the extruder mixing sections such that they may be starve fed, if desired. For example, the flighted sections may have wide flights and shallow channels.

Each of the extruder mixer sections 1001 or 1002 are generally similar, but may have differing aspect ratios (L/D) as shown in FIG. 1. For example, the extruder mixer sections 1001, 1002 may have an aspect ratio of 0.25, 0.50, 0.75, 1, 1.25 1.5, 1.75, 2, 2.25, 2.5, 2.7, 3, 3.25, 3.5, 3.75, 4, 4.25, 4.5, 4.75, 5, 5.25, 5.5, 5.75, or 6, although lower and higher aspect ratios are also contemplated. The aspect ratio of the mixer sections 1000, 1001 is not particularly limited, but may be in the range of from 0.25 to 6, from 1 to 4, or from 2 to 3. The aspect ratio is defined as the length L of each of the extruder mixers 1001, 1002 along the screw 100, divided by the nominal diameter D of the screw 100. In the case of the extruder mixers 1001, they are each 5 inches (12.7 cm) long and the screw has a nominal diameter of 1 inch (2.54 cm) and therefore the L/D of the extruder mixer sections 1001 is 5. Similarly, the extruder mixer sections 1002 are about 2.7 inches (7 cm) long and therefore have an L/D aspect ratio of about 2.7.

In FIG. 1A, the feed section 10 of the screw 100 is shown on the left and the screw end 12 is shown on the right of the figure. Thus, a plasticized flowable material flows through an extruder from the feed section 10 of the screw 100 to the end 12 thereof as the rotatable screw 100 rotates. For reference purposes, throughout this description, “upstream” is thus relatively closer to the feed section 10, than to the screw end 12, and “downstream” is relatively closer to the screw end 12 than to the feed section 10. It may be seen in FIG. 1A that the outlet channel 1601, 1602 feeds into the inlet channel 1401, 1402 of a mixing section immediately downstream.

According to an embodiment, the extruder screw 100 may comprise a barrier section immediately upstream of the first mixing section. As is known in the art, a barrier screw or barrier section of a screw may comprise an auxiliary or barrier flight, as is known in the art. The barrier flight effectively separates a “solid channel” and “melt channel.” The solid channel is open to the upstream feed section while the melt channel is open to the upstream of the first mixing section. While the solid channel depth decreases along the length of the screw, the melt channel depth increases. As the solid bed melts along the length of the feedscrew, the melted polymer flows over the barrier flight into the melt channel through a tight clearance. The barrier clearance prevents any unmelted pellets from flowing into the melt channel. Therefore, the first mixing section will be fed with melted polymer.

FIGS. 1B, 1C, 1D, and 1E show cross-sectional views of the extruder mixers 1000, and 1002, taken along the lines A-A, B-B, C-C, and D-D, respectively. As can be seen in these cross-sectional views, in addition to the inlet channels 1401, 1402 and outlet 1601, 1602 channels, there are flights and one or more intermediate channels 1801, 1802 therebetween.

As seen in FIG. 1A, each mixing section 1001, 1002, has a respective inlet channel 1401, 1402 and outlet channel 1601, 1602. These are arranged in analogous fashion and therefore for simplicity and ease of understanding, the following discussion is directed only to the mixing section 1001. It will be understood by a person skilled in the art that other mixing sections, such as the second embodiment mixing section 1002 are arranged in a similar fashion and will differ only in certain details such as the size of channels in the mixing section and/or the L/D for example, but the arrangement and functionality are as described throughout for an exemplary extruder mixer section 1001. FIG. 1F shows an exemplary embodiment of an extruder mixer section 1001 showing a vacuum seal in the form of a blister 1702 that is arranged perpendicular relative to the screw axis. The blister 1702 bridges the inlet channel 1401 and the outlet channel 1601 downstream. The blister 1702 has a small clearance to the extruder barrel such that the molten polymer in order to pass over it from the inlet channel 1401 to the outlet channel 1601. The molten polymer thus provides a vacuum seal. The blister 1702 may have a clearance to the extruder barrel from 0.01 to 0.06 inches (0.254 cm to 0.1524 cm), for example. The clearance may be from 0.02 to 0.05 inches (0.0508 cm to 0.127 cm) or from 0.03 to 0.04 inches (0.0762 cm to 0.1016 cm). Those skilled in the art will recognize that the clearance from the blister 1702 to the extruder barrel may vary depending on screw size. According to an embodiment, the blister 1702 may be placed in the input channel to encourage melting, rather than just as vent seal.

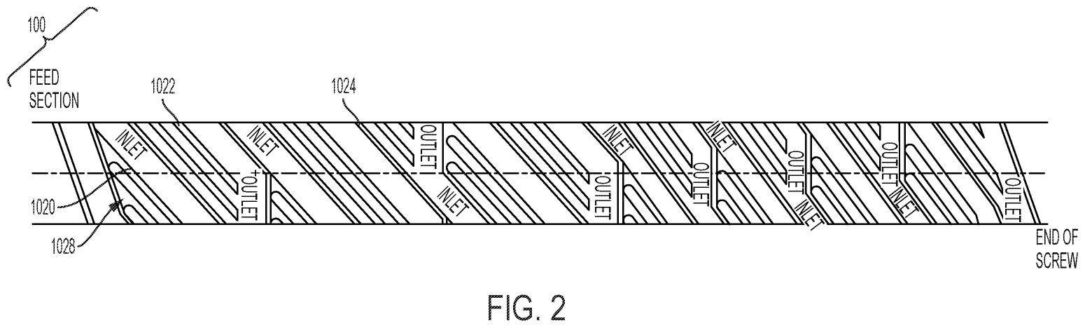

FIG. 2 is another rendition of the elongated rotatable screw 100 showing the extruder mixer sections 1001, 1002. Looking only at the first embodiment extruder mixer section 1001 on the elongated rotatable extruder screw 100, it may be seen that in addition to the inlet channel 1401, there is an intermediate channel 1801, a first pump 2001 interposed between a downstream side of the inlet channel 1401 and the upstream side of the intermediate channel 2001. There is also a second pump 2201 interposed between the downstream side of the intermediate channel 1401 and an upstream side of the outlet channel 1601. A downstream flight portion 2401 is positioned along the outlet channel 1601, and an optional transverse flight portion 2601 is oriented transverse relative to the downstream flight portion 2401. If present, the transverse flight portion 2601 may be positioned so as to terminate the downstream ends of the inlet channel 1401 and the intermediate channel 2001.

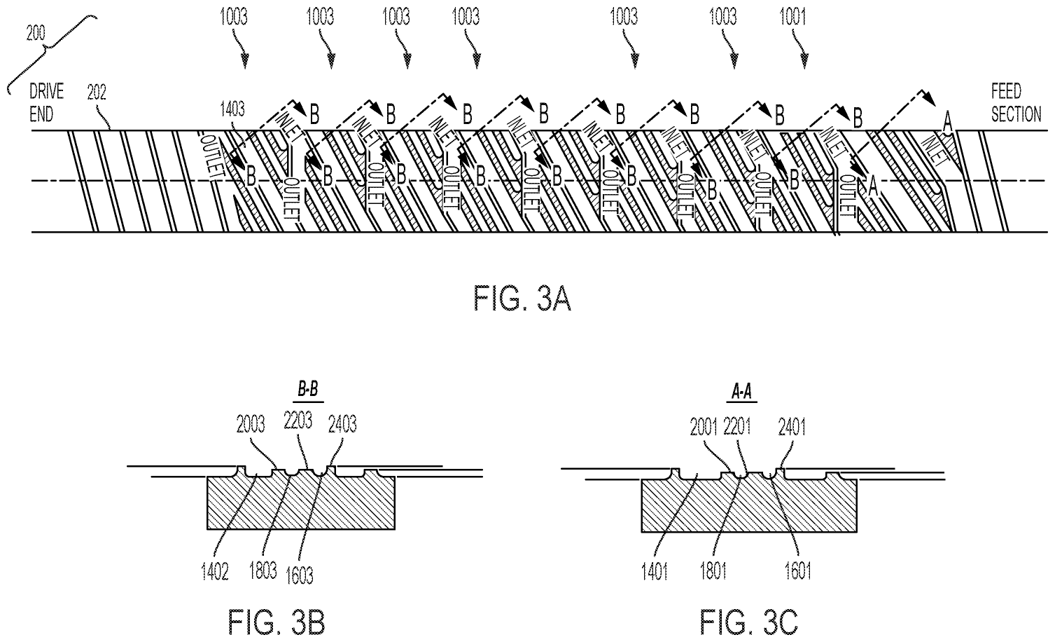

FIG. 3A illustrates another embodiment of an elongated rotatable extruder screw 200. In this embodiment 200, there are 8 extruder mixer sections 1003, each having an L/D of 3 and an extruder mixer section 1001, having an L/D of 5. This embodiment of an elongated rotatable extruder screw 200 also includes a flighted section 202, upstream of the first mixing section 1003. The purpose of the flighted section 202 is to control a flow of plasticized flowable material into an upstream opening of the inlet channel 1403 of the mixing section 1003.

As may be seen in FIGS. 1, 2 and 3, the inlet and outlet channels 1401, 1402 and 1601, 1602 as well as the intermediate channels 1801 and 1801 are angled relative to a central axis 11 of the elongated rotatable screw 100, 200, 300. This angle may be from 5 to 85 degrees, or from 20 to 70 degrees, or from 30 to 60 degrees or from 40 to 50 degrees relative to the central axis 11 of the elongated rotatable screw 100, 200, 300. For example, the angle illustrated in FIGS. 1, 2 and 3 is about 45 degrees. The intermediate channels 1801, 1802 may be generally parallel to the inlet channels 1401, 1402, or they may be arranged in a non-parallel fashion, as will be described below.

FIGS. 3B and 3C are cross-sectional views of extruder mixing sections 1003 and 1001 respectively. These cross-sectional views show how the first pump 2001, 2003 and second pump 2201, 2203 have heights that are lower than a height of the downstream flight portion 2401, 2403 and the optional transverse flight portion 2601 (not shown in the cross-sectional view). This means that a clearance between an extruder barrel (not shown) and the downstream flight portion 2401, 2403 and the optional transverse flight portion 2601 is less than the clearance between an extruder barrel and the first pump 2001, 2003 and second pump 2201, 2203. Suitable clearances for the first pump 2001, 2003 and second pump 2201, 2203 depend on the exact geometry of the screw and the extruder mixing sections, but may vary from 0.03 inches to 1.0 inch (0.0762 to 2.54 cm), 0.04 to 0.8 inch (0.1016 to 2.032 cm), or from 0.03 to 0.5 inches (0.0762 to 1.27 cm), for example. Clearances may be changed, depending on the nominal diameter of the screw.

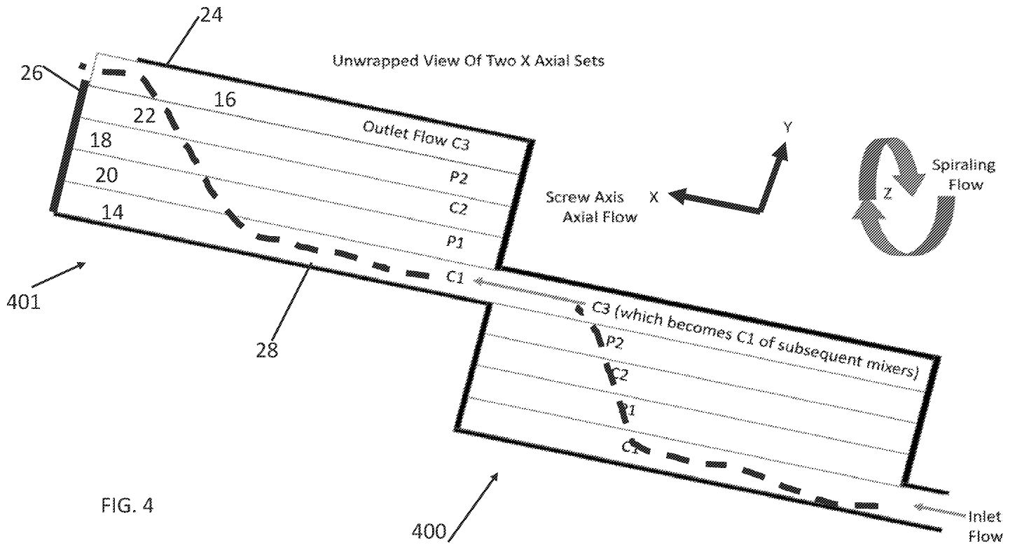

FIG. 4 shows an “unwrapped” view of two exemplary extruder mixer sections 400 and 401. In this view, it should be understood that the extruder mixer sections have been unwrapped in the axial, X direction as denoted on the Figure. Extruder section 400 is upstream of extruder mixer section 401. In FIG. 4, flow of plasticized flowable material should be understood to go from right to left on the Figure, and is denoted by the direction X. Thus, “upstream” and “downstream” refer to the bulk flow direction from right to left. The flow also moves axially through the extruder mixing sections of the invention, but this will be described in more detail later. Thus, in each of the mixer sections 400 and 401, it may be seen that flight portions, channels and pumps are arranged as follows.

The inlet channel 14 may be bound at the downstream end by the optional transverse flight portion 26 and at the downstream side by the first pump 20. The first pump 20 is bound at the upstream side by the inlet channel 14, at the downstream side by the intermediate channel 18, and at a downstream end by the optional transverse flight portion 26, if present. The intermediate channel 18 is bound at the upstream side by the first pump 20, at the downstream side by the second pump 22, and at the downstream end by the optional transverse flight portion 26. The second pump 22 is bound at the upstream side by the intermediate channel 18, at a downstream side by the outlet channel 16, and at the downstream end by the optional transverse flight portion 26. The outlet channel 16 is open at the downstream end and bound at a downstream side by the downstream flight portion 24 and at the upstream side by the second pump 22. Thus, if present, the transverse flight portion 26 may be seen to be oriented transverse relative to the downstream flight portion 24 and therefore the optional transverse flight portion 26 may be positioned to terminate the downstream ends of the inlet channel 14 and the intermediate channel 18. Although not shown in FIG. 4, the heights of the downstream flight portion 24 and the transverse flight portion 26 are greater than heights of the first pump 20 and the second pump 22 in a direction radially outward from the central axis of the elongated rotational screw.

FIG. 4 shows that the downstream opening of the outlet channel 16 of the upstream mixing section 400 is in flow communication with the upstream opening of the inlet channel 14 of the downstream mixing section 401. The heavy dashed arrows in FIG. 4 show how the flow of the plasticized flowable material enters the inlet channel 14 of the upstream extruder mixing section 400 at the right of the figure. Because the downstream end of the inlet channel 14 is blocked by the transverse flight portion 26 (if present), the plasticized flowable material flows across the first pump 20 into the intermediate channel 18. Because of the drag of the screw (or barrel, according to the usual convention) the plasticized flowable material will be dragged across the pump 20, even if the transverse flight portion is not present. The intermediate channel 18 likewise may be blocked at its downstream end by the transverse flight portion 26 (if present). Thus, the plasticized flowable material flows over the second pump 22 and into the outlet channel 16, due to drag. The downstream end of the outlet channel of mixing section 400 is in flowable communication with the upstream end of the inlet channel 14 of the downstream mixing section 401. Therefore, the plasticized flowable material flows into the inlet channel 14 of downstream mixing section 401, and flow repeats through the downstream mixing section 401.

Although discussed above, it may be seen in FIG. 4 as well, that the direction of the inlet channel 14 is oriented at an angle of 30 to 60 degrees, or 40 to 50 degrees relative to the central axis 11 of the elongated rotational screw 10.

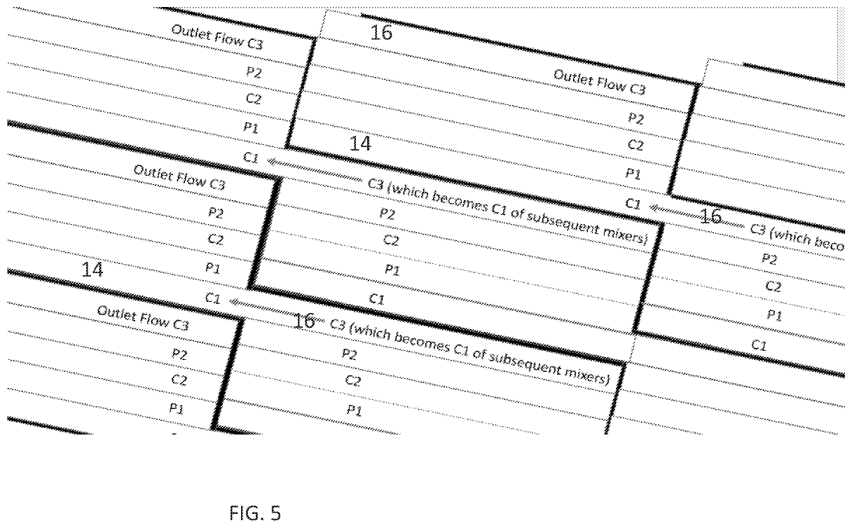

FIG. 5 shows an unwrapped view of an arrangement of multiple extruder mixer sections of the invention, similar to FIG. 4, where “upstream” is understood to be to the right and downstream to the left of FIG. 5. It may be seen in FIG. 5, that the outlet channel 16 of each upstream mixing section becomes the inlet channel 14 of the immediately downstream mixing section.

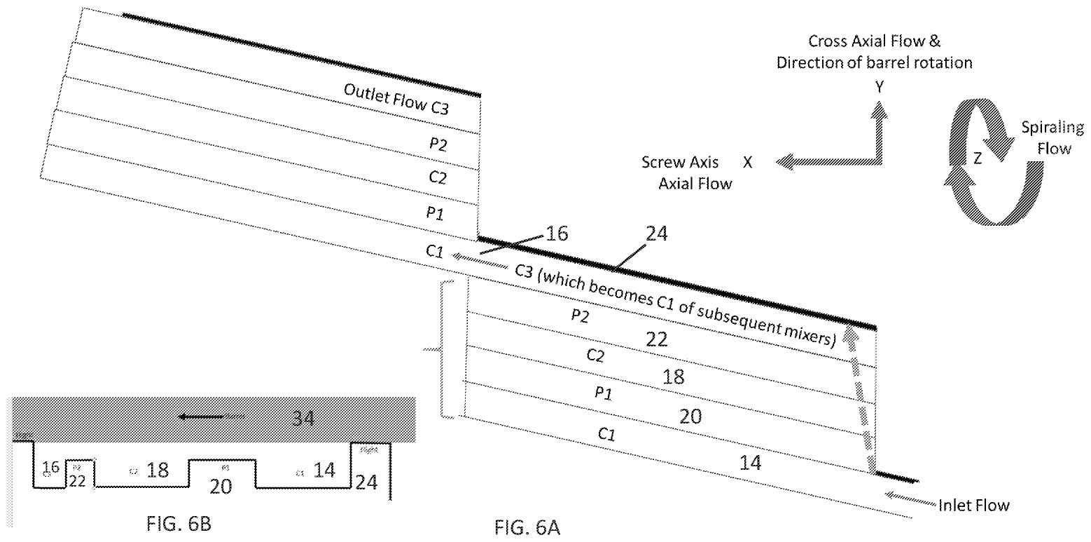

FIG. 6 shows another unwrapped view of the an arrangement of multiple extruder mixer sections of the invention, similar to FIG. 4, where “upstream” is understood to be to the right and downstream to the left of FIG. 6. It may be seen in FIG. 6, that the optional transverse flighted portion is not present. The barrel flow, according to convention, moves in the Y direction. Accordingly the plasticized flowable material (e.g. polymer) moves mostly in the Y-direction, although it has a small X component. Because of this, the extruder mixer sections 400, 401, 4001, 1002, 1003 do not need to have the downstream ends of the inlet and intermediate channels 14, 18 bound by the transverse flight portion 26. Likewise the upstream end of the outlet channel does not need to be bound by the transverse flight portion 26 either.

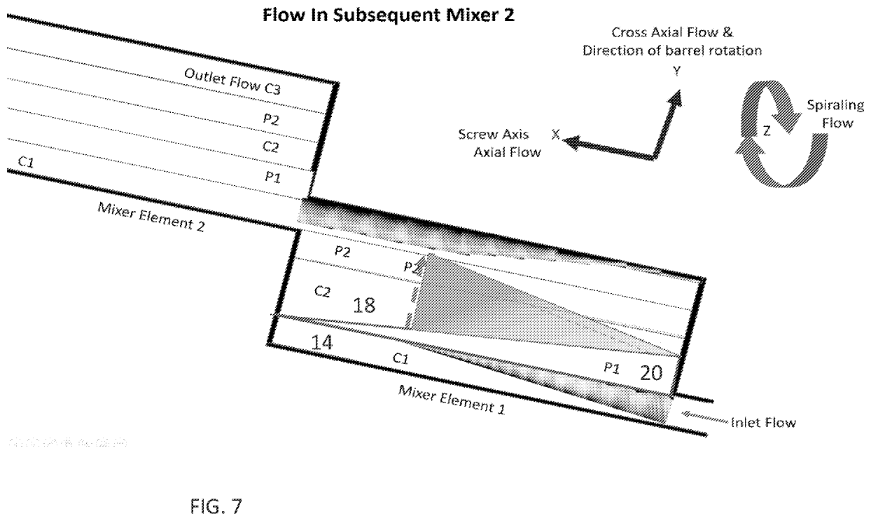

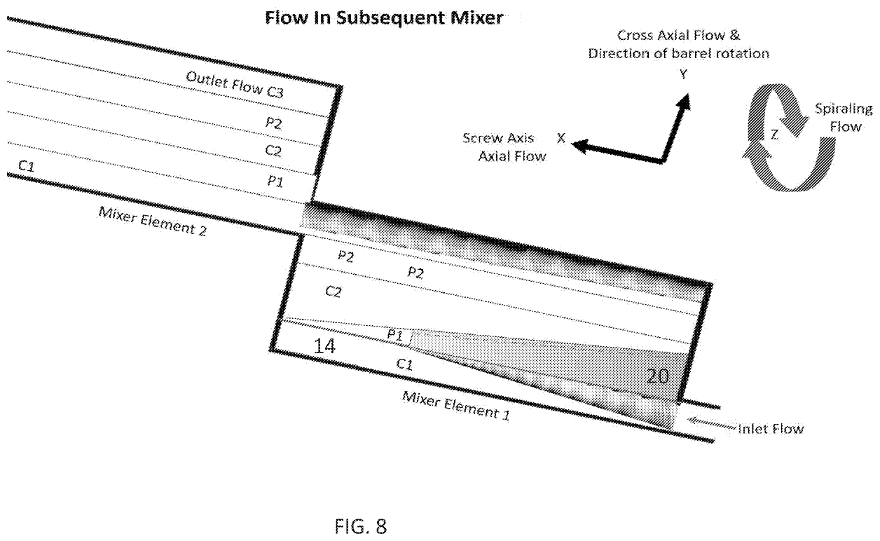

FIG. 6 shows a view of two extruder mixer sections without the optional transverse flight portion 26. Various geometries of the first pump are possible. For example, as shown in FIGS. 7 and 8, the first pump 20 may be arranged at an angle relative to the inlet channel 14. The first pump 20 may be arranged at an angle of 15 to 85 relative to the direction of the inlet channel 14. The first pump 20 may be arranged at an angle of from 20 to 60, or from 30 to 50 or from 40 to 60 relative to the direction of the inlet channel 14, this providing a variation in width of the intermediate channel 18 along the screw axis. Likewise, the second pump 22 may be arranged at an angle of from 20 to 60 or from 30 to 50, or from 40 to 70 or from 40 to 60 relative to the outlet channel 16, which will a provide a variation in the width of the intermediate channel 18 along its length. For example, the width may vary from 0.050 to 7 inch (0.127 cm 17.78 cm) or from 0.15 to 3 inches (0.381 to 7.62 cm) or from 0.125 to 0.5 inches (0.3175 to 1.27 cm).

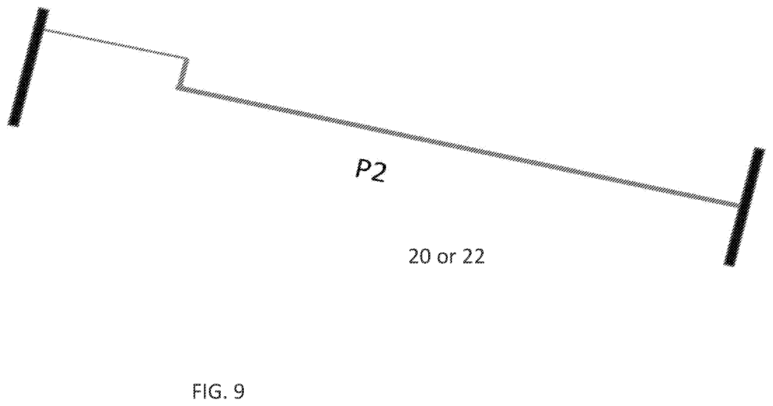

As shown in FIG. 9, the first pump 20 and or the second pump 22 may also vary in height along their length. It is preferable, as shown in FIG. 9, that if the height of the first pump 20 or the second pump 22 varies in height, that it is higher towards the downstream end thereof. Thus, the clearance from the top of the first pump 20 and/or the second pump 22 to an extruder barrel may be smaller at the downstream end than at the upstream end. This variation may be from 0.02 inches to 0.1 inches (0.025 cm to 0.25 cm) or from 0.040 to 0.08 inches (0.1016 to 0.2032 cm) or from 0.008 to 1 inch (0.02032 to 2.54 cm).

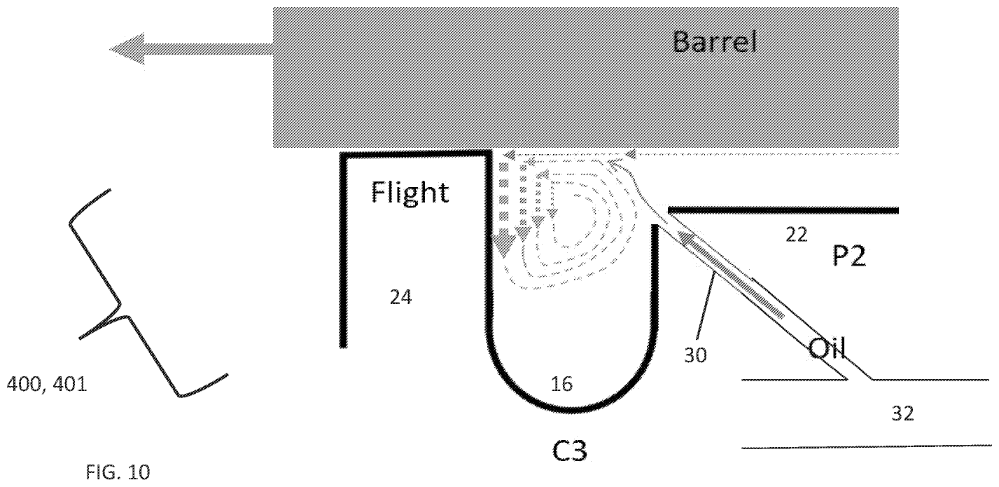

In another embodiment, shown in partial cross-section in FIG. 10, the extruder mixer 400, 401 may further include a fluid insertion aperture 30 located in the outlet channel 16. As shown in FIG. 10, the fluid insertion aperture 30 may be advantageously placed at a downstream edge or side of the second pump 22. The fluid insertion aperture 30 is configured and arranged to be in fluid connection with a fluid delivery passage 32 within the elongated rotatable screw. The fluid insertion aperture could be a slot. There may be more than one such aperture 30 located at the downstream edge or side of the second pump 22. As can be seen in FIG. 10, the downstream flight portion 24 has a smaller clearance to an extruder barrel 34, than the second pump 22. The fluid that is added may be a liquid or may be fluidized particles carried by a gas, or may be a gas.

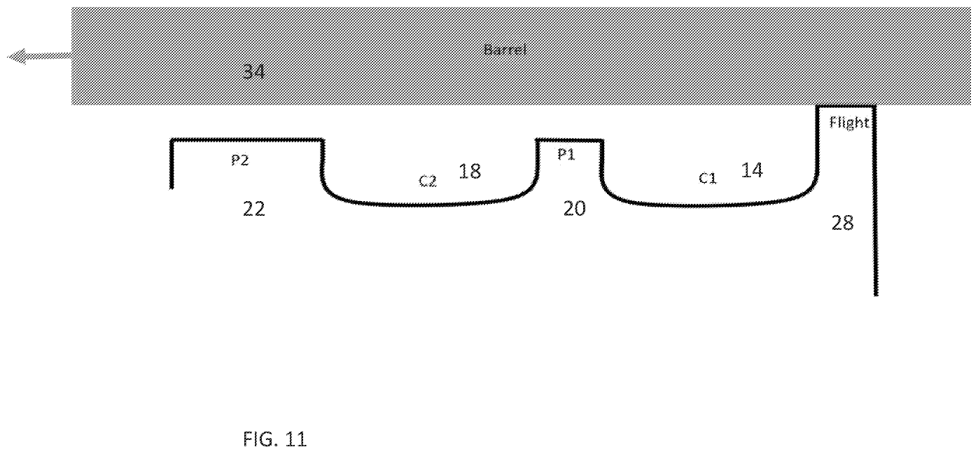

FIG. 11 shows a cross-section of a mixing section 400, 401. In this cross-sectional view, it can be seen that the height of the first pump 20 and the second pump 22 are lower than the upstream flight portion 28. Accordingly, the clearance between the upstream flight portion 28 (and also the downstream flight portion and the transverse flight portion, neither shown) are smaller than the clearance of the first 20 and second pumps 22 to an extruder barrel 34. The width of the inlet channel 14 may be wider or the same as the intermediate channel 18. The widths of the inlet channel 14 and the outlet channel 16 are desirably the same. For example, the inlet channel 14 and the outlet channel 16 may be from 0.02 inches to 0.1 inches (0.025 cm to 0.25 cm) or from 0.040 to 0.08 inches (0.1016 to 0.2032 cm) or from 0.008 to 1 inches (0.0635 to 2.54 cm) wide. The intermediate channel may be from 0.02 inches to 0.1 inches (0.025 cm to 0.25 cm) or from 0.040 to 0.08 (0.1016 to 0.2032 cm) inches or from 0.008 to 1 inch (0.0635 to 2.54 cm) wide. Likewise, the channel depths may vary as well. For example, the depth of the inlet and outlet channels 14, 16 may be about 0.180 inches, or from 0.1 to 0.375 inches (0.254 to 0.9525 cm) as measured from their lowest point to the top of the first pump 20 or the second pump 22. Likewise, the depth of the intermediate channel 18 may be from 0.1 to 0.375 inches (0.254 to 0.9525 cm) as measured from its lowest point to the top of the first pump 20 or the second pump 22. If the pumps 20, 22 are of different heights, the depth of the respective channel is considered to be the smaller measurement. For all of the forgoing dimensions, the dimensions may scale generally with the screw diameter, such that smaller screws will tend to have the smaller dimensions and larger screws will accordingly tend to have the larger dimensions.

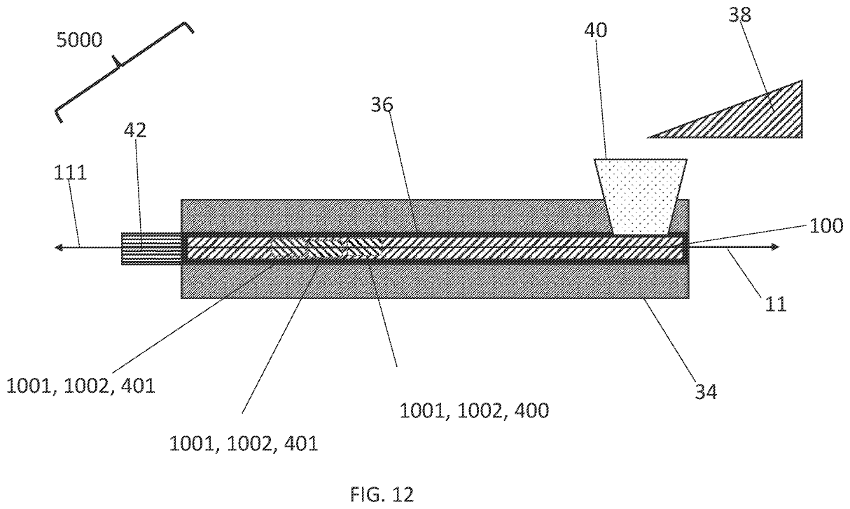

FIG. 12 shows an extruder system 5000 that includes an extruder barrel 34 having a bore 36 extending along its central axis 111. The central axis 111 of the extruder barrel 34 is coincident with the central axis 11 of the rotatable screw 100. The extruder system 5000 includes a polymer feeder 38 associated with the extruder barrel 34. As shown in FIG. 12, the polymer feeder 38 may be above or next to the extruder barrel 34 or above an extruder hopper 40 or may be coupled directly to the extruder barrel 34 or the extruder hopper. The polymer feeder 38 is configured to feed polymer into the bore 36 of the extruder barrel 34. Also included in the extruder system 5000 is an elongated rotatable screw 100 that extends within the bore 36 of the extruder barrel 34. The screw 100 is mounted for rotation about the central axis 111 of the extruder barrel 34. As seen in FIG. 12, one or more extruder mixers 1001, 1002, 400, 401 of any of the embodiments of the invention is provided on the elongated rotatable screw 100 and configured to mix the polymer fed to the bore 36 of the extruder barrel 34. The extruder system 5000 may also include a die 42.

### Process

Referring generally to the figures, the present invention provides a method for mixing polymer in an extruder system, a method for reducing hygroscopic properties of a hygroscopic polymer in an extruder system, and a method of inhibiting the formation of bubbles in extrudate of a hygroscopic polymer using an extruder system. The present invention also provides a method of mixing particulates, e.g. pigments, fillers, etc. into a polymer.

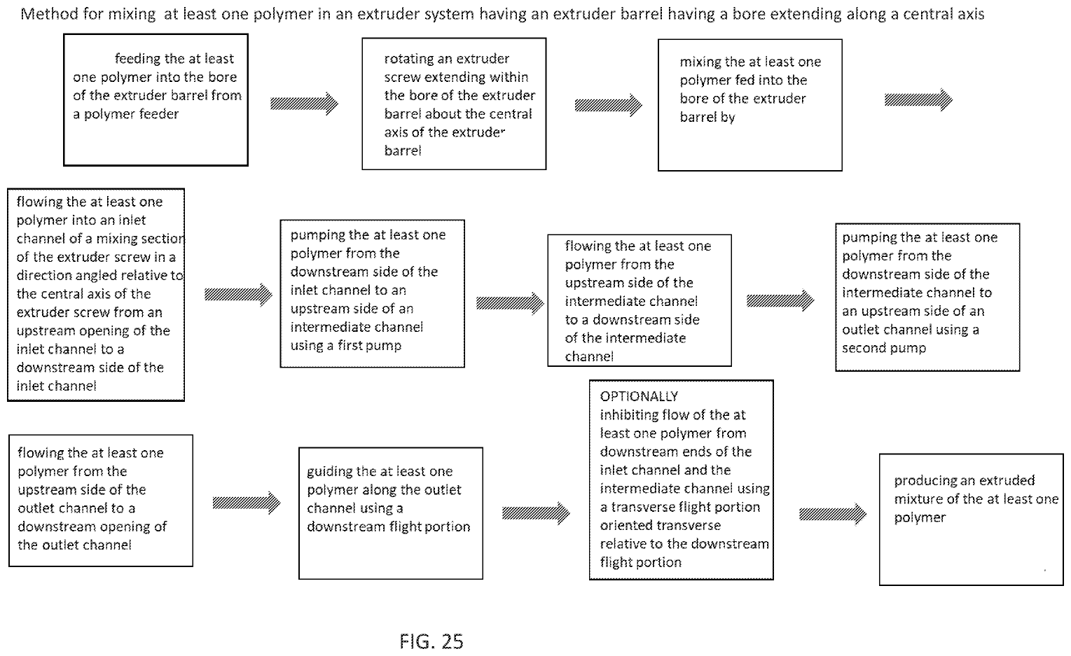

FIG. 25 shows a method for mixing at least one polymer in an extruder system 5000 having an extruder barrel 34 having a bore 36 extending along a central axis 11. As seen in FIG. 25, the method comprises the following steps.

First, feeding the at least one polymer into the bore 36 of the extruder barrel 34 from a polymer feeder 38. Then, rotating an extruder screw 100, 200 extending within the bore 36 of the extruder barrel 34 about the central axis 11 of the extruder barrel 34. Next, mixing the at least one polymer fed into the bore 36 of the extruder barrel 34 by flowing the at least one polymer into an inlet channel 14, 1401, 1402, 1403 of a mixing section 400, 401, 1001, 1002, 1003 of the extruder screw 100, 200 in a direction angled relative to the central axis 11 of the extruder screw 100, 200 from an upstream opening of the inlet channel 14, 1401, 1402, 1403 to a downstream side of the inlet channel. After that, pumping the at least one polymer from the downstream side of the inlet channel to an upstream side of an intermediate channel 18, 1801, 1802, 1803 using a first pump 20, 2001, 2002, 2003. Next, flowing the at least one polymer from the upstream side of the intermediate channel to a downstream side of the intermediate channel. Then pumping the at least one polymer from the downstream side of the intermediate channel to an upstream side of an outlet channel 16, 1601, 1602, 1603 using a second pump 22, 2201, 2202, 2203. After that, flowing the at least one polymer from the upstream side of the outlet channel to a downstream opening of the outlet channel. Then, guiding the at least one polymer along the outlet channel using a downstream flight portion 24, 2401, 2402, 2403 to thereby produce an extruded mixture of the at least one polymer.

According to another embodiment, after guiding the at least one polymer along the outlet channel 16, 1601, 1602, 1603 using a downstream flight portion 24, 2401, 2402, 2403, mixing at least one polymer further comprises a step of inhibiting flow of the at least one polymer from downstream ends of the inlet channel and the intermediate channel using a transverse flight portion 26, 2601, 2602, 2603 oriented transverse relative to the downstream flight portion 24, 2401, 2402, 2403.

According to a further embodiment of mixing the at least one polymer, the polymer comprises at least two polymers. The method may further comprise a step of feeding at least one additive into the bore 36 of the extruder system 5000. According to yet another embodiment, the method may further comprise a step of venting the mixing section 400, 401, 1001, 1002, 1003.

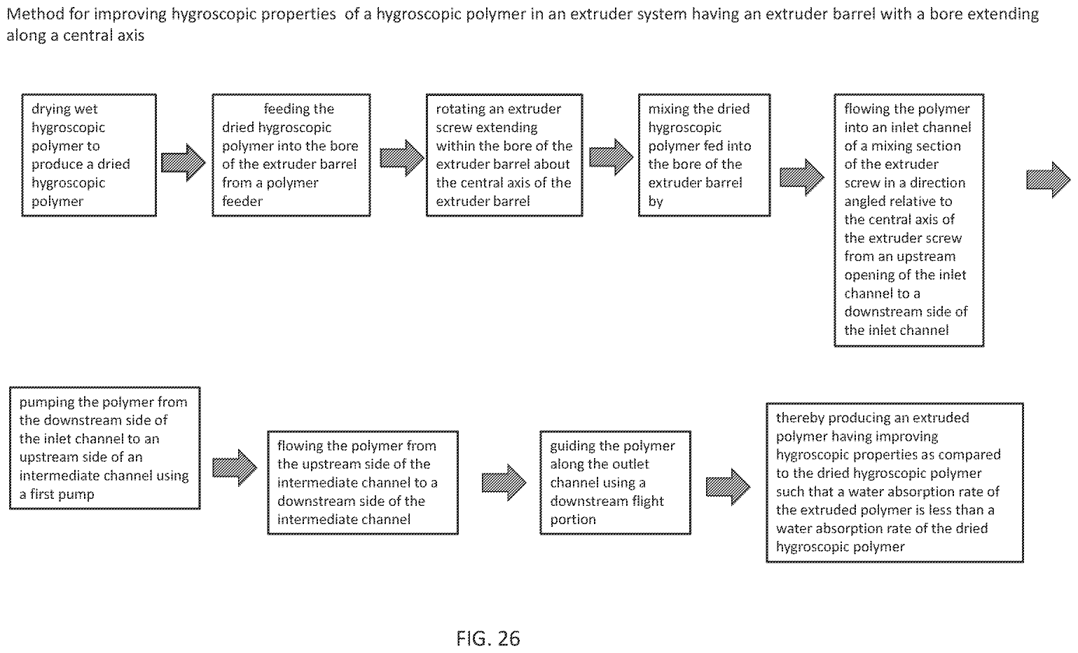

A method for reducing hygroscopic properties of a hygroscopic polymer in an extruder system 5000 having an extruder barrel with a bore extending along a central axis is provided. This method is shown in FIG. 26. The method comprises the following steps. First, drying wet hygroscopic polymer to produce a dried hygroscopic polymer. Then feeding the dried hygroscopic polymer into the bore 36 of the extruder barrel 34 from a polymer feeder 38. Next, rotating an extruder screw 100, 200 extending within the bore 36 of the extruder barrel 34 about the central axis 11 of the extruder barrel 34. Then, mixing the dried hygroscopic polymer fed into the bore 36 of the extruder barrel 34 by first, flowing the polymer into an inlet channel 14, 1401, 1402, 1403 of a mixing section 400, 401, 1001, 1002, 1003 of the extruder screw 100, 200 in a direction angled relative to the central axis 11 of the extruder screw 100, 200 from an upstream opening of the inlet channel to a downstream side of the inlet channel. After that, pumping the polymer from the downstream side of the inlet channel to an upstream side of an intermediate channel 18, 1801, 1802, 1803 using a first pump 20, 2001, 2002, 2003. Then, flowing the polymer from the upstream side of the intermediate channel to a downstream side of the intermediate channel. Next, pumping the polymer from the downstream side of the intermediate channel to an upstream side of an outlet channel using a second pump 22, 2201, 2203. After that, flowing the polymer from the upstream side of the outlet channel to a downstream opening of the outlet channel. Then guiding the polymer along the outlet channel using a downstream flight portion 24, 2401, 2402, 2403. Thus, producing an extruded polymer having reduced hygroscopic properties as compared to the dried hygroscopic polymer such that a water absorption rate of the extruded polymer is less than a water absorption rate of the dried hygroscopic polymer.

According to another embodiment of reducing hygroscopic properties of a hygroscopic polymer, after guiding the at least one polymer along the outlet channel using a downstream flight portion, a step of inhibiting flow of the polymer from downstream ends of the inlet channel and the intermediate channel using a transverse flight portion 26, 2601, 2602, 2603 oriented transverse relative to the downstream flight portion may be performed. According to yet another embodiment, the feeding may be performed while maintaining a pressure in the extruder mixer section 400, 401, 1001, 1002, 1003 of less than 75 psi.

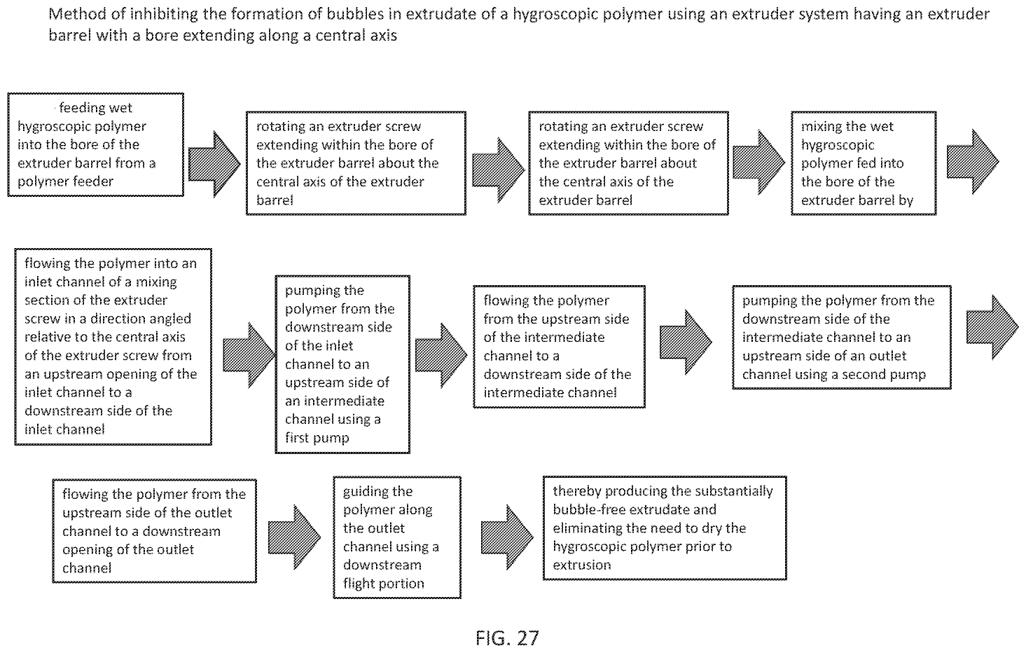

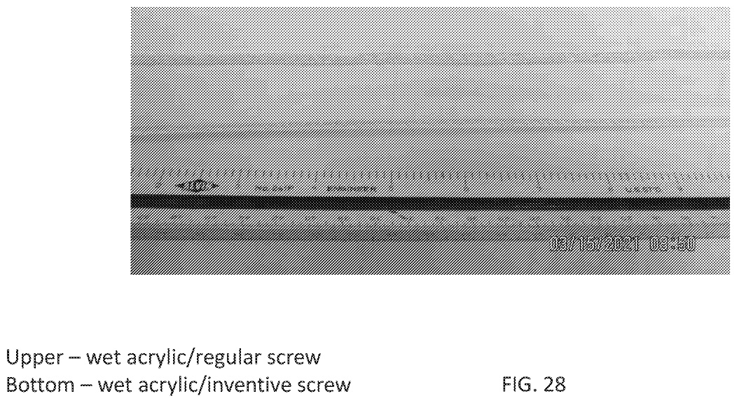

FIG. 27 shows a method of inhibiting the formation of bubbles in extrudate of a hygroscopic polymer using an extruder system 5000 having an extruder barrel 34 with a bore 36 extending along a central axis 11. As shown in FIG. 27, the method comprises the following steps. First, feeding wet hygroscopic polymer into the bore 36 of the extruder barrel 34 from a polymer feeder 38. Next, rotating an extruder screw 100, 200 extending within the bore 36 of the extruder barrel 34 about the central axis 11 of the extruder barrel 34. Then, mixing the wet hygroscopic polymer fed into the bore 36 of the extruder barrel 34 by performing the following steps. First, flowing the polymer into an inlet channel 14, 1401, 1402, 1403 of a mixing section 400, 401, 1001, 1002, 1003 of the extruder screw 100, 200 in a direction angled relative to the central axis 11 of the extruder screw 100, 200 from an upstream opening of the inlet channel to a downstream side of the inlet channel. Next, pumping the polymer from the downstream side of the inlet channel to an upstream side of an intermediate channel using a first pump 20, 2001, 2002, 2003. Then, flowing the polymer from the upstream side of the intermediate channel to a downstream side of the intermediate channel. After that, pumping the polymer from the downstream side of the intermediate channel to an upstream side of an outlet channel 16, 1601, 1602, 1603 using a second pump 22, 2201, 2202, 2203. Then, flowing the polymer from the upstream side of the outlet channel to a downstream opening of the outlet channel. After that, guiding the polymer along the outlet channel using a downstream flight portion 24, 2401, 2402, 2403, thus producing the substantially bubble-free extrudate and eliminating the need to dry the hygroscopic polymer prior to extrusion.

According to another embodiment, the method for inhibiting bubble formation in the extrudate of a hygroscopic polymer may further comprise, after guiding the at least one polymer along the outlet channel 16, 1601, 1602, 1603 using a downstream flight portion, a step of inhibiting flow of the polymer from downstream ends of the inlet channel and the intermediate channel using a transverse flight portion 26, 2601, 2602, 2603 oriented transverse relative to the downstream flight portion. According to yet another embodiment, the feeding may be performed while maintaining a pressure in the extruder mixer section 400, 401, 1001, 1002, 1003 of less than 75 psi.

Referring now to specific embodiments shown in the figures for purposes of illustration, details of exemplary embodiments of a method for mixing polymer in an extruder system, a method for reducing hygroscopic properties of a hygroscopic polymer in an extruder system, and a method of inhibiting the formation of bubbles in extrudate of a hygroscopic polymer using an extruder system will now be described.

A method for mixing at least one polymer in an extruder system 5000 having an extruder barrel 34 having a bore 36 extending along a central axis 11 is provided. The method includes the following steps.

Feeding a plasticized flowable material, such as at least one polymer into the bore 36 of the extruder barrel 34 from a polymer feeder 38. According to an embodiment of the invention, the plasticized flowable material may be starve fed in the bore 36 of the extruder barrel 34 from a polymer feeder 38. As is understood in the art, starve feeding occurs when the at least one polymer is metered into the extruder bore 36 by a feeding device 38. There is no accumulation in the hopper 40 (if present); the material instead drops directly onto the screw 100, and the channels of the screw 100 and thus the channels of the extruder mixer(s) are only partially full. The partial full channels are beneficial for accomplishing good mixing and therefore starve feeding the inventive extruder mixer section is desirable, but is optional.

If done, starve feeding can be accomplished by use of an upstream extruder, a pump, a solids starve feeder, or reducing the volume of an upstream channel, for example. Starve feeding may also be accomplished by adjusting the rotational speed (RPM) of the screw. If the extruder mixer is starve fed, the pressure should be low, e.g. close to zero or zero or less than zero at a point immediately upstream of the inlet channel 14 or at a point near the inlet of the second pump 22, i.e. at the downstream end of the intermediate channel 18. As is known in the art, this pressure may vary as the screw rotates.

Rotating the extruder screw 100 extending within the bore 36 of the extruder barrel 34 about the central axis 111 of the extruder barrel 34. As mentioned, adjusting this rotational speed may be done in order to achieve starve feeding of the extruder mixer section(s).

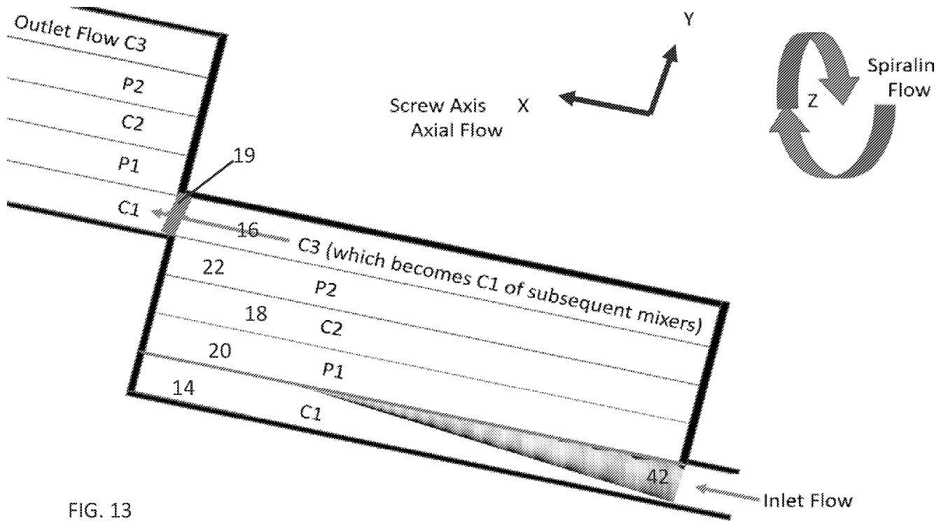

As seen in FIG. 13, mixing of the plasticized flowable material (e.g. at least one polymer) 42 fed into the bore 36 of the extruder barrel 34 occurs by flowing the at least one polymer 42 into an inlet channel 14 of a mixing section 400, 401, 1001, 1002 of the extruder screw 100 in a direction angled relative to the central axis 11 of the extruder screw 100 from an upstream opening of the inlet channel 14 to a downstream side of the inlet channel 14.

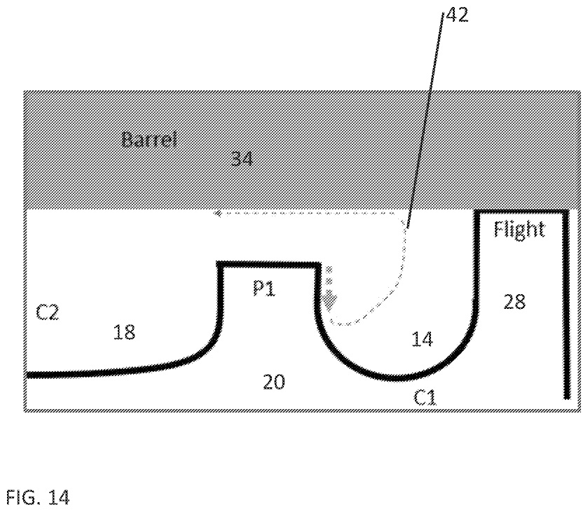

As also shown in cross-section in FIG. 14, the at least one polymer 42 is then pumped from the downstream side of the inlet channel 14 to an upstream side of an intermediate channel 18 using a first pump 20. Without wishing to be bound by any theory, this flow may cause a spiraling flow of the at least one polymer 42 at the downstream side of the inlet channel 14. This possibly spiraling flow goes over the pump 20 into the intermediate channel 18. As shown in FIG. 14, the inlet channel 14 is only partially full. This is desirable, since it enables the spiraling mixing flow to occur.

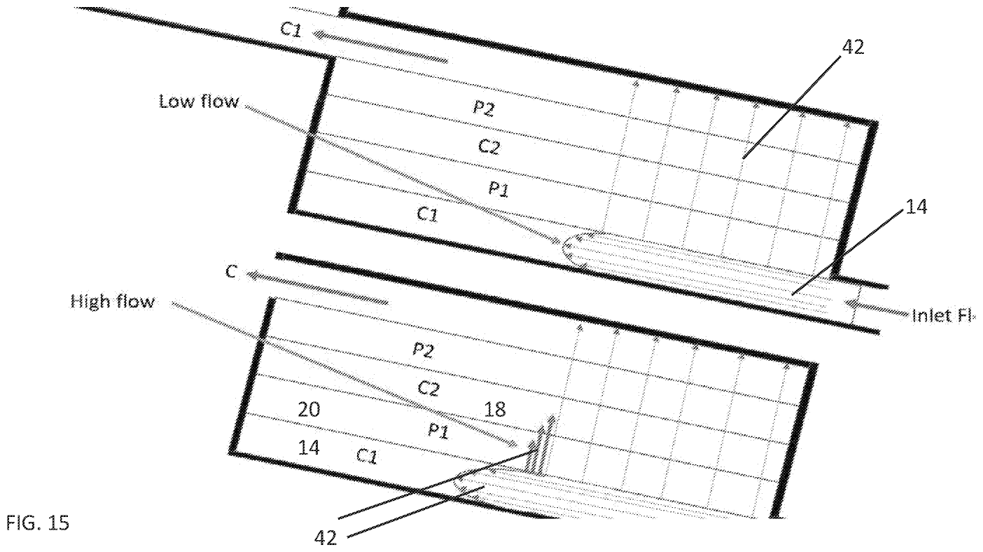

The partial fill of the inlet channel 14 may be achieved by optionally starve feeding the extruder mixer section. According to another embodiment, the extruder mixer may be flood fed, i.e., the .inlet channel may be full. If the inlet channel 14 is full (flood feeding) the mixing may not be as effective. In this case, it is common to see a pressure fluctuation immediately upstream of the inlet channel 14. FIGS. 15A and 15B show another view of the at least one polymer 42 flow (represented by the upward arrows) flowing from the downstream end and side of the inlet channel 14 over the first pump 20 into the intermediate channel 18.

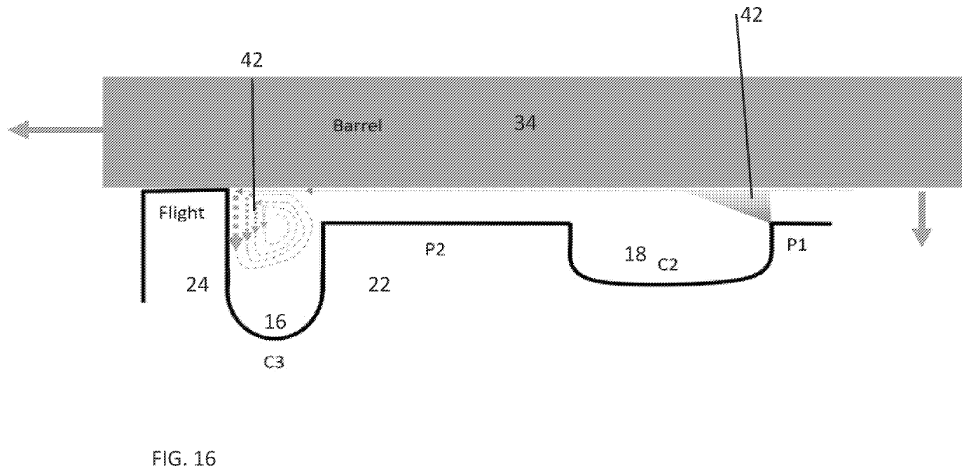

FIG. 16 shows a cross-sectional view of flowing the at least one polymer 42 from the upstream side of the intermediate channel 18 to a downstream side of the intermediate channel 18, and then pumping the polymer 42 from the downstream side of the intermediate channel 18 to an upstream side of an outlet channel 16 using a second pump 22. FIG. 16 shows a view of flowing the at least one polymer 42 from the upstream side of the outlet channel 16 to a downstream opening of the outlet channel 16. Also shown in FIG. 16 is guiding the at least one polymer 42 along the outlet channel 16 using a downstream flight portion 24.

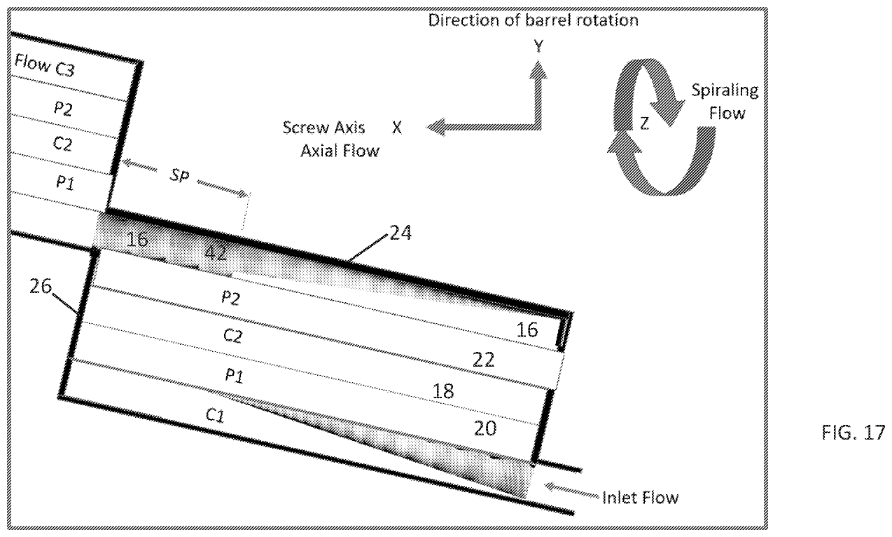

FIG. 17 further shows optional inhibiting flow of the polymer 42 from downstream ends of the inlet channel 14 and the intermediate channel using an optional transverse flight portion 26 oriented transverse relative to the downstream flight portion 24, thereby producing an extruded polymer 42. According to this method, the starve feeding may be performed while maintaining a pressure in the extruder bore 36 of less than 50-100 psig. This pressure is preferably 0, but may vary from 0 to 50 or 100 psig as the screw 100 rotates and depending also on the polymer viscosity. The pressure is desirably measured at a point that is upstream of the inlet channel 14. The pressure may also be measured at a point that is at the inlet of the second pump 22. If these pressures are not less than 50-100 psi gauge, starve feeding may be reestablished by increasing the screw 100 rotational speed or by decreasing the feed rate of polymer to the screw.

According to another embodiment, at least two polymers may be mixed by feeding at least two polymers to the extruder mixing section. According to yet another embodiment, an additive (a fluid, a liquid, a particulate or a gas) may be fed to the extruder mixer section and thus mixed with the at least one polymer.

Given a fixed input flow into the inventive extruder mixer element (as from another extruder or the many well-known feeding mechanisms), increased screw speed will convey the plasticized flowable material at a greater rate. Since the feed is constant, this causes filled volume of the inlet 14 and outlet 16 channels to decrease. By adjusting the screw RPM upward, the pressure at the inlet to the second pump will become about zero and the plasticized flowable material is then restricted to the upstream channel 14 wall, as shown in FIG. 14.

Since the output of the screw is constant at a given rotational speed, decreasing the feed rate from the upstream extruder or feeding device, will decrease the volume of material in the channel. By downward adjustment of the volume of feed, the pressure will decrease until it is zero and properly filled. Since the inlet channel 14 has length, a range of fill (and output) along the side of the channel 14 is possible.

The inventive extruder mixer section may then convey material to a downstream pump (for example the metering section of a screw or a gear pump) to build sufficient pressure to overcome upstream resistance, for example, from a die. Such pumps may constructed and arranged to match the output of the inventive extruder mixer section. However, because the extruder mixer section is capable of a range of outputs, the extruder mixer section can flexibly match the output of any downstream pump.

Also provided is a method for reducing hygroscopic properties of a hygroscopic polymer. By “reducing hygroscopic properties”, it is meant that there is an impact on the tendency of the polymer to absorb moisture from the air. For example, improvement reduction in hygroscopic properties can be a reduction in the tendency of a polymer's ability to absorb moisture from the air or a reduction in the amount of moisture absorbed from the air by the polymer, as compared to the tendency (or amount) of water absorption of the polymer if not processed according to the invention.

The inventor has discovered that polymers that typically require drying prior to extruding in order to produce substantially defect-free parts or parts with reduced bubble formation, can, if dried before being processed through the inventive extruder mixer, no longer require drying prior to subsequent processing, even after extended storage in wet conditions to produce substantially defect-free parts or parts having reduced bubble formation. Non-limiting examples of such polymers that generally require drying before processing, that would benefit from this process are acrylates and copolymers thereof; polyethylene terephthalates; polycarbonates; polyetheretherketone, polyetherketoneketone and the like; polyetherimides; styrene acrylonitrile; polybutylene terephthalate polyester; nylons; polyphenylene sulfides; acrylonitrile butadiene styrene; polylactic acid; polymers containing hygroscopic fillers such as titanium dioxide, carbon black, or certain colorants; thermoplastic polyurethanes; and copolymers and blends thereof.

This method for reducing the hygroscopic properties of a hygroscopic polymer in an extruder system 5000 having an extruder barrel 34 with a bore 36 extending along a central axis 111 includes the following steps.

First, drying wet hygroscopic polymer to produce a dried hygroscopic polymer. By “dried” is meant achieving a lower water content that the wet polymer. This drying step may be done under suitable conditions for the particular polymer as are known in the art. Non-limiting examples include vacuum and ambient heated driers for example. Typically, these employ desiccants in order to provide dried air to the polymer.

Next, feeding the dried hygroscopic polymer into the bore 36 of the extruder barrel 34 from a polymer feeder 38. According to an embodiment of the invention, the polymer may be starve fed into the bore 36 of the extruder barrel 34. According to an embodiment of the invention, the polymer may be flood fed into the bore 36 of the extruder barrel 34.

Then rotating an extruder screw 100 extending within the bore 36 of the extruder barrel 34 about the central axis 111 of the extruder barrel 34 occurs to produce a flow of polymer.

Mixing the dried hygroscopic polymer occurs as the polymer is fed into the bore 36 of the extruder barrel 34 by flowing the polymer into an inlet channel 14 of a mixing section 400, 401, 1001, 1002 of the extruder screw 100 in a direction angled relative to the central axis 11 of the extruder screw 100 from an upstream opening of the inlet channel 14 to a downstream side of the inlet channel 14.

Then, the polymer is pumped from the downstream side of the inlet channel 14 to an upstream side of an intermediate channel 18 using a first pump 20.

The next steps are flowing the polymer from the upstream side of the intermediate channel 18 to a downstream side of the intermediate channel 18 and pumping the polymer from the downstream side of the intermediate channel 18 to an upstream side of an outlet channel 16 using a second pump 22.

Then, flowing the polymer from the upstream side of the outlet channel 16 to a downstream opening of the outlet channel 16, where it is guided along the outlet channel 16 using a downstream flight portion 24. The flow of the polymer from downstream ends of the inlet channel 14 and the intermediate channel 18 may be inhibited by an optional transverse flight portion 26 oriented transverse relative to the downstream flight portion 24.

This method produces an extruded polymer having reduced hygroscopic properties as compared to the dried hygroscopic polymer such that a water absorption rate of the extruded polymer is less than a water absorption rate of the dried hygroscopic polymer. The method thus produces an extruded hygroscopic polymer that, when processed after storage in pelletized (pellets ¼ in or smaller in largest dimension) or granular form for three days or more at 25° C. and 50% relative humidity, will produce a defect free part without the need for drying prior to extrusion.

The flow of the polymer through the extruder mixer section(s) 400, 401, 101, 1002 is the same in this method as described above for the mixing method. According to this method, the feeding may be performed while maintaining a pressure in the extruder bore 36 of less than 50 or less than 75 or less than 100 psig. Desirably, this pressure is measured at a point immediately upstream of the inlet channel 14. As is known in the art, the pressure may vary depending on the viscosity of the polymer being extruded. The pressure will also vary as the screw rotates.

A method of producing a substantially bubble-free (or substantially defect-free) extrudate from a hygroscopic polymer in an extruder system 5000 having an extruder barrel 34 with a bore 36 extending along a central axis 11 is provided. The method comprises the following steps.

First, feeding wet hygroscopic polymer into the bore 36 of the extruder barrel 34 from a polymer feeder 38. Then, rotating an extruder screw 100 extending within the bore 36 of the extruder barrel 34 about the central axis 111 of the extruder barrel 34.

Mixing of the wet hygroscopic polymer fed into the bore 36 of the extruder barrel 34 occurs by flowing the polymer into an inlet channel 14 of a mixing section 400, 401, 1001, 1002 of the extruder screw 100 in a direction angled relative to the central axis 11 of the extruder screw 100 from an upstream opening of the inlet channel 14 to a downstream side of the inlet channel 14. The polymer is then pumped from the downstream side of the inlet channel 14 to an upstream side of an intermediate channel 18 using a first pump 20. The polymer then flows from the upstream side of the intermediate channel 18 to a downstream side of the intermediate channel 18. The polymer is pumped from the downstream side of the intermediate channel 18 to an upstream side of an outlet channel 16 using a second pump 22. Then the polymer flows from the upstream side of the outlet channel 16 to a downstream opening of the outlet channel 16, where it is guided along the outlet channel 16 using a downstream flight portion 24. Flow of flow of the polymer from downstream ends of the inlet channel 14 and the intermediate channel 18 may be inhibited using an optional transverse flight portion 26 oriented transverse relative to the downstream flight portion 24.

This method thereby produces a substantially bubble-free extrudate and eliminates the need to dry the hygroscopic polymer prior to extrusion.

According to this method, the feeding may be performed while maintaining a pressure in the extruder bore 36 of less than 50 or less than 75 or less than 100 psig.

### Applications

Non-limiting examples of uses for the present inventive extruder mixer section, and extrusion screws and extruder systems that comprise the extruder mixer section are as follows.

Pelletizing hygroscopic polymers directly out of a reactor to produce hygroscopic polymers that do not need to be dried. These inventive extruder mixing sections, and extrusion systems including them may be used as the pelletizing extruder or they may be used to feed such an extruder.

There are many types of polymer inclusions or defects whose local concentrations may be reduced by use of the inventive extruder mixing section, such as gels, additives, carbon specs, degraded polymer and crystals for property improvement.

Since polymers have a range of molecular weights, the inventive extruder mixer section may be used to evenly distribute the lower weight polymer chains, to lower their local concentration and thereby improve bulk properties of the polymer.

Another use is mixing particulate or low viscosity additives, especially hygroscopic additives into polymers. Non-limiting examples of such additives are blowing agents (especially particulate blowing agents), oils, fillers, colorants, plasticizers, and other particulate additives for any number of purposes, such as fibers, nanofibers, graphene, carbon nanotubes, carbon black, flame retardants, antioxidants, and other functional additives. Nylons may be mixed with fillers that would otherwise not be well-dispersed into nylon. Cellulose including a plasticizer may also be mixed into suitable polymers. Plasticizers may be advantageously incorporated into PVC (polyvinylchloride) as well.

Making blends (alloys) of disparate polymers. For example, certain polymers are difficult to blend with others and the use of the inventive extruder mixing section may provide a more complete, uniform mixing of blends. For example, polystyrene and HDPE may be advantageously blended together to form a suitable composite. Polymers having very different viscosities at the same temperature may also be advantageously blended together using the inventive extruder mixer section.

These mixing elements can be usefully employed after a single screw or twin screw extruder to enhance mixing. For example, in a polymer reactor, there is typically an existing single or twin screw extruder. An extruder with a screw employing a mixing element according to the invention may be placed after these existing extruders.

### Theory of Operation

Without wishing to be bound to any particular theory, the inventor believes that the extruder mixer of this invention may operate according to the following description.

As shown in FIG. 14, the inlet channel 14 is a constant depth over its length. The material entering the inlet channel 14 optionally may be limited to less than the inlet channel's 14 volume, such as, by limiting the feed (often called starving the channel). If desired, this is readily accomplished with an upstream extruder, a pump, a solids starve feeder, or reducing the volume of an upstream channel, for example.

By limiting or starving this portion of the extruder mixer section, material is dragged down the inlet channel 14 by the barrel 34 along the side of first pump 20 at the arrow. (Recall that we are using the convention where the barrel moves around the screw.) The flow of material is also being pulled upward as depicted by the dotted lines, thus providing a spiraling flow that stretches and is narrower towards the downstream end of the inlet channel 14. The flow to the left over the top of the first pump 20 arrow is conserving this down channel spiraling flow. It should be appreciated that the core of the flow is flowing down channel. Since the inlet channel is not full, the (gauge) pressure therein is zero.

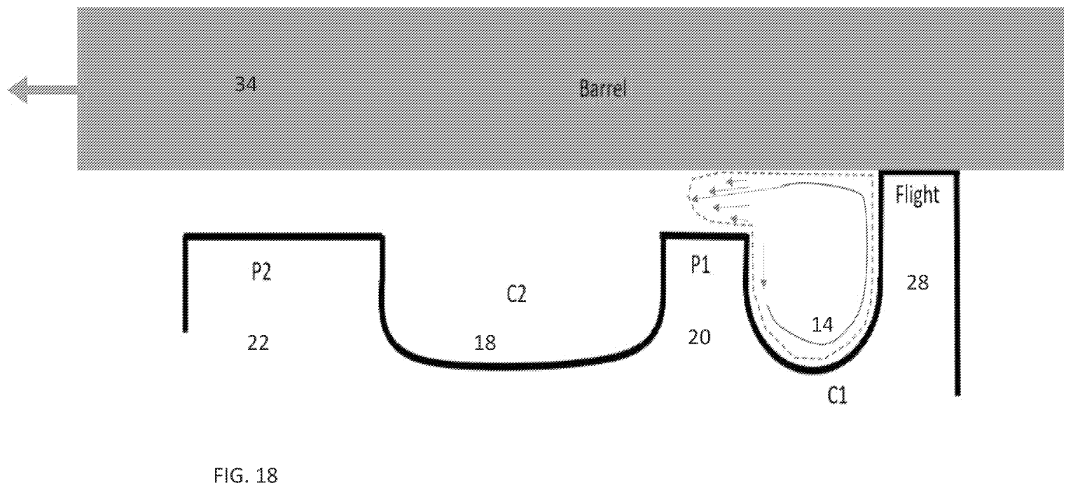

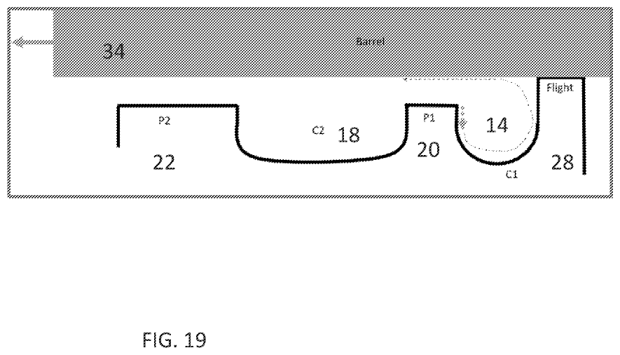

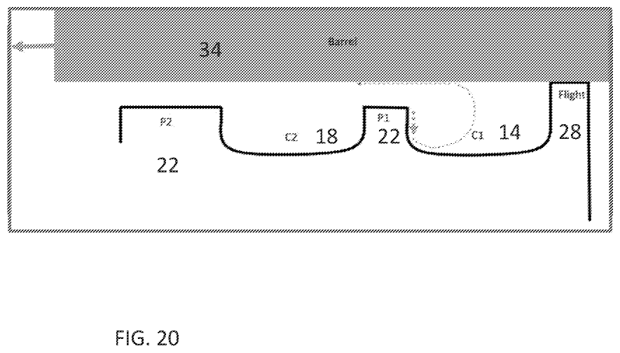

This flow may be thought of as “tethered stretching.” The flow is tethered at the arrow, since it is not moving relative to the downstream side of the inlet channel 14, but otherwise is free to stretch as it is pulled downstream by the barrel 34 within the otherwise empty inlet channel 14. This results in part of the flow moving downstream, part of the flow rotating and thinning, and part of the flow moving along the y direction along the barrel and over the first pump 20. Different filling amounts are shown schematically at FIGS. 18, 19 and 20 as the spiraling flow moves down the inlet channel 14. Maximum tethered stretching is approximated by the smallest circles.

FIG. 17 shows how the material in the inlet channel 14 may be shaped like a turritella shell, placed lengthwise in the inlet channel 14 with the large end at the inlet end. The flow may be a diminishing spiral because the first pump 20 pumps the plasticized flowable material at a constant rate (assuming the first pump 20 clearance does not change), thus draining the plasticized flowable material evenly until the inlet channel is empty. Because the first pump 20 clearance is at the top of the inlet channel 14 flow, it drains away the outermost portion of the available inlet channel flow. The innermost portion of the inlet channel 14 flow has an X axis component.

The number of rotations of the inlet channel 14 flow may be is less at the upstream of the inlet flow (because of the difference in diameter) than at the downstream (assuming a constant clearance for the first pump 20). The Z axis rotation within the inventive extruder mixer section may be approximately calculated as follows. (The friction of the plasticized flowable material at the tethered region is neglected in the following discussion.) The barrel velocity may be thought of as the perimeter of the extruder's inside barrel. Assuming the barrel diameter is one inch (2.54 cm), the length is 3.14 inches (7.98 cm) per rotation. The flow may be approximated as a right cone. At the upstream end of the inlet channel 14, assuming a depth of 0.180 inches (0.4572 cm), the perimeter of the inlet channel 14 would be 0.562 inches (1.4275) cm). This is about 5 twists per rotation (3.14/0.562=5.5; or 7.98/1.4275). The furthest downstream portion (the sharp end of conical shaped spiraling flow) would be 0.04 inches (0.1016 cm) diameter, since that is the first pump 20 clearance to the barrel. Thus, per rotation of the screw, (3.14×0.04=0.1256 and 3.14/0.1256=˜25) there may be about 25 times or about half an order of magnitude rotational difference between upstream and downstream ends of the inlet channel 14. This is in contrast to classic channel flow in the metering section of a single screw extruder screw, which provides approximately 1 rotation per 1 L/D of the screw.

The outermost material of the rotating spiral of flow in the inlet channel 14 is removed by the first pump 20 and the diminishing core moves downstream. The surface of the inlet channel 14 flow continuously exposes new material. This may provide the following advantages. In a two stage single screw with barrel venting, the flow against the pushing side of a flight does not expose the core of the flowing material. This means that gases trapped within the core (i.e., near the screw root) cannot easily escape. However, the flow within the inlet channel 14 of the single screw extruder mixer is constantly exposing new material. This means that gases may easily escape, providing opportunities for venting and devolatilizing processes. Material may easily be added to the continually expanding surface and may be continually evenly mixed in, providing opportunities for addition of low viscosity liquids or fine particulates at downstream portions of the extruder, as discussed above.

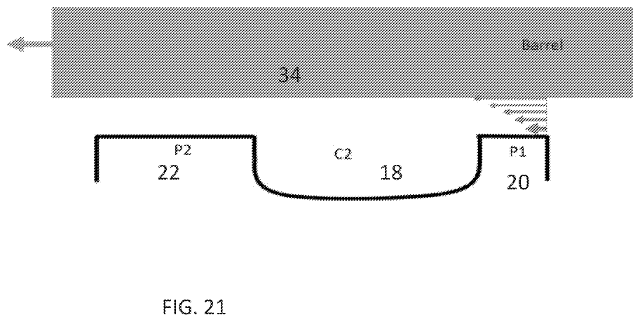

Simple planar shear is well known to mix. FIG. 21 shows the planar flow over the first pump 20. Since there is no pressure in the inlet channel 14, the planar shear in the first pump 20/barrel gap may be optimized for shear heating and minimal temperature rise. All the material may pass over the first pump 20 evenly (assuming the first pump 20 clearance to the barrel 34 is unchanging).

Shear rate is calculated as:

(3.14 D N)/clearance over first pump 20 (s⁻¹)

D is the barrel 34 inner diameter and N is the screw rotational speed in revolutions per second (RPS). Thus, at 120 RPM (equals 2 RPS), for a 1 inch (2.54 cm) barrel extruder and a clearance of 0.04 inches (0.1016 cm), the shear rate is approximately 157 s⁻¹. For larger extruders, to avoid excessive shear rate over the first pump 20, the clearance to the barrel may be increased.

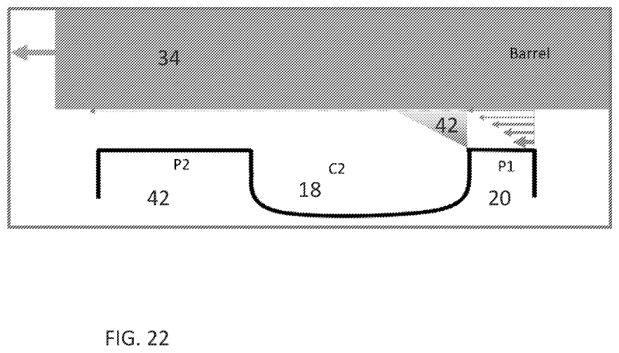

FIG. 22 shows how flow over the first pump 20 may tether the plasticized flowable material. The velocity of the material at the barrel 34 is much higher than the discharge velocity at the first pump 20 uppermost surface. Unconstrained, the barrel 34 quickly stretches the material away from the tethered surface at the first pump 20. As shown by the arrow over the intermediate channel 18, the stretched film above the intermediate channel 18 and against the barrel 34 in one experiment was measured to be about 1 mil (25 microns) and since the first pump 20/barrel gap was about 40 mils (1 mm), the Y axis draw-down ratio is exponential and constantly creating new surface.

This creation of new surface provides certain advantages. For example, the exposure of new surface means that gases may easily escape. Additives, fillers, etc. may be easily be added to the continually expanding surface and is therefore continually evenly mixed into the plasticized flowable material. Since the film of plasticized flowable material against the barrel 34 may be thin, energy transfer between the plasticized flowable material film and barrel 34 may be enhanced. This may be especially advantageous when heat needs to be removed, such as from elongation, or when using the inventive extruder mixer for cooling, such as after injection of physical blowing agents. Thus, the purpose of the second pump 22 may be to define the intermediate 18 channel as a region for extension of the plasticized flowable material, and to pump when necessary.

Referring back to FIG. 16, it may be seen that the outlet channel 16 receives the thin film of plasticized flowable material that is dragged along by the barrel 34 until it encounters the downstream flight portion 24. Plasticized flowable material over the downstream flight portion 24 may be resistive to flow, causing most of the plasticized flowable material 42 to migrate down the downstream flight portion 24, shown by the larger dashed arrow. This flow will release from the downstream flight portion 24 wall because it is being pulled upward by the barrel 24 and stretched to become thinner. This is the third tethered stretching that may occur within one inventive extruder mixer section. With each rotation, the dashed flow lines become thinner, moving towards the core of the spiraling flow. The flow will thus move in three dimensions.

Note that the direction of rotation in the outlet channel 16 is the same as in the inlet channel 14. Therefore, the Z axis rotation that occurred in the inlet channel 14 is further enhanced. As in FIG. 13, this may add another order of magnitude to the degree of mixing. As shown in FIG. 17, the outlet channel 16 flow is again shaped like a turritella shell but now with the small end upstream, such that the flow is a widening spiral. Looking again at FIG. 17, it may be appreciated that the flow in the region of the outlet channel 16 marked SP may be empty or filled. When the SP region of the outlet channel 16 full, it may act as a seal that is necessary for vacuum degassing when paired with another such seal in another extruder mixer section (either upstream or downstream). Thus, any one extruder mixer section may be sealed if desired. The seal might be several extruder mixer sections later so that all the surfaces from the several extruder mixer sections can remove gases through a single vent. According to another embodiment of the mixer section as shown in FIG. 13, there may be an optional blister 19 that bridges across the opening from the outlet channel of one mixer section to the inlet channel of the next (downstream) mixer section. The blister 19 has a small clearance to the barrel in the radial direction such that only plasticized flowable material (i.e., molten polymer) can go over the blister 19, thus providing a vacuum seal between the two mixer sections. According to an embodiment, the blister 19 may be oriented in a direction perpendicular to the screw axis. The orientation of the blister 19 is not particularly restricted, as long as it bridges across the opening from the outlet channel of one mixer section to the inlet channel of the next (downstream) mixer section. For example, the blister may be oriented at 45 degrees relative to the screw axis. According to another embodiment, the blister 19 may be placed downstream in the inlet channel. In this embodiment, the would encourage material to flow over the P1 pump.

The blister may be any suitable size, as long as the clearance to the barrel is a suitable size to permit only plasticized flowable material to flow between it and the extruder barrel. The size and clearance may be selected depending on the screw and barrel size as well as the viscosity of the plasticized flowable material. For example, for a 1 inch (2.54 cm) barrel diameter, the blister may have a width of 0.25 inches (0.635 cm) and a clearance of 0.035 inches (0.0889 cm).

Gases (dry air or nitrogen for example) may be used to conveniently pick up particulate additives and convey them to a particular extruder mixer section, or through many extruder mixer sections, distributing additive to the many available exposed surfaces of the plasticized flowable material. This may be particularly suitable for incorporating additives such as carbon nanotubes or graphene because they are light and dusty and will stick to the many surfaces for very fine distribution. Such a sealed system can contain dangerous carbon dust within the extruder barrel. Fibers, such as carbon nanotubes for example, may stick to the exposed surface of the plasticized flowable material and align in three dimensions, as they move from one extruder mixer section to another. Graphene may tend to lay flat in the thin film over the intermediate channel 18 and the second pump 22 and wind at the outlet channel.

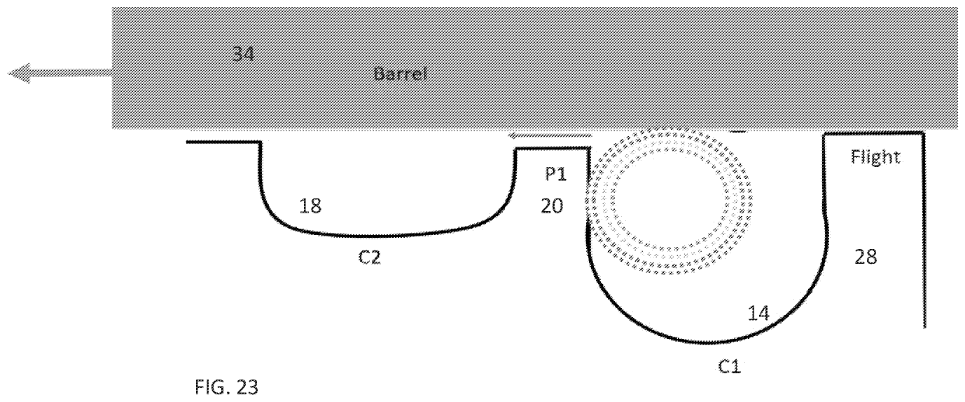

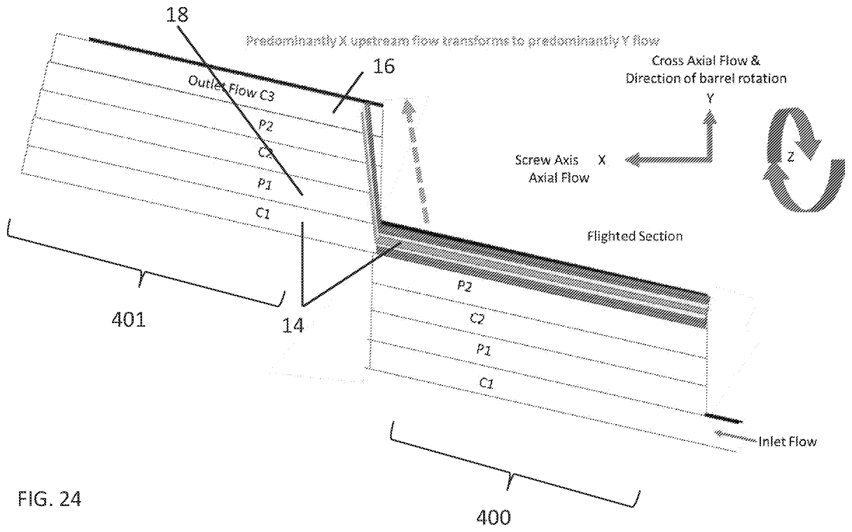

FIG. 23 shows how, as the plasticized flowable material may become more finely mixed with every subsequent extruder mixer section, the plasticized flowable material may be thought of as a series of concentric thin layers proceeding (but not drawn) to the core and represented in the inlet channel as concentric dotted line circles. It should be understood that these concentric circles of flow continue to the center, but are not drawn, for clarity. FIG. 24 shows a transition of the x-axis flow of a plasticized flowable material from an upstream extruder mixer section 400 through a y-axis flow to a downstream extruder mixer section 401. This transition from predominately x-axis flow through a y-axis flow and then an-x-axis flow is surprising and contributes to the mixing. In the outlet channel 14 of the upstream extruder mixer section 400 a cross section of flow about to enter the inlet channel 14 of the downstream extruder mixer section 401 is shown. The layers are shown parallel to the outlet channel 14 axis.

As shown in FIG. 24, in the inlet channel 14 of the downstream extruder mixer section 401 (which also is the outlet channel of the upstream mixing section 400), the layers will peel off from outside in predominately the y-direction while finely spiraling, as shown in FIG. 23. It should be understood that the parallel lines in the channel 14 of the up the upstream mixer 400 are simultaneously flowing the x-direction, while spiraling in the z direction, due to the rotation of the extruder screw. The effect is illustrated in cross-section in FIG. 23. As the spiraling flow is pulled across the flight 18 (P1) in the mixing section 401, it transitions to y-axis flow. The flow is thus reoriented when it arrives at the across the outlet channel 16 of the downstream extruder mixer section 401. Previously, the Z and Y direction mixing were shown to be exponential. During the transformation from the outlet channel 16 of an upstream extruder mixer 400 to the outlet channel 16 of the downstream extruder mixer section, X direction flow may be transformed into Y direction flow and thus becomes exponentially mixed.

The invention may be summarized according to the following exemplary aspects.

Aspect 1. An extruder mixer positioned about a central axis of an elongated rotatable screw, the extruder mixer comprising:
at least one mixing section between upstream and downstream ends of the elongated rotatable screw, each of the at least one mixing section having:
   an inlet channel oriented in a direction angled relative to the central axis of the elongated rotatable screw, the inlet channel having an upstream opening, a downstream end, and a downstream side,
   an intermediate channel circumferentially spaced from the inlet channel and oriented along the direction of the inlet channel, the intermediate channel having an upstream side, a downstream end, and a downstream side,
   an outlet channel circumferentially spaced from the intermediate channel and oriented along the direction of the inlet channel, the outlet channel having an upstream side, a downstream side, and a downstream opening,
   a first pump interposed between the downstream side of the inlet channel and the upstream side of the intermediate channel,
   a second pump interposed between the downstream side of the intermediate channel and the upstream side of the outlet channel, and
   a downstream flight portion positioned along the outlet channel;
wherein the inlet channel, the intermediate channel, the output channel, the first pump, the second pump, and the downstream flight portion are arranged as follows:
   the inlet channel is bound at the downstream side by the first pump,
   the first pump is bound at the upstream side by the inlet channel, and at the downstream side by the intermediate channel;
   the intermediate channel is bound at the upstream side by the first pump, and at the downstream side by the second pump;
   the second pump is bound at the upstream side by the intermediate channel, and at a downstream side by the outlet channel; and
   the outlet channel is open at the downstream end and bound at a downstream side by the downstream flight portion and at the upstream side by the second pump;
wherein a height of the downstream flight portion is greater than heights of the first pump and the second pump in a direction radially outward from the central axis of the elongated rotational screw.

Aspect 2. The extruder mixer of Aspect 1, comprising a transverse flight portion oriented transverse relative to the downstream flight portion, the transverse flight portion being positioned to terminate the downstream ends of the inlet channel and the intermediate channel, wherein:
the inlet channel is bound at the downstream end by the transverse flight portion;
the first pump is bound at the downstream end by the transverse flight portion;
the intermediate channel is bound at the downstream end by the transverse flight portion; and
the second pump is bound at the downstream end by the transverse flight portion;
and wherein a height of the transverse flight portion is greater than the heights of the first pump and the second pump in a direction radially outward from the central axis of the elongated rotational screw.

Aspect 3. The extruder mixer of either Aspect 1 or Aspect 2, comprising at least two mixing sections, one of the at least two mixing sections being an upstream mixing section and another one of the mixing sections being a downstream mixing section, wherein the downstream opening of the outlet channel of the upstream mixing section is in flow communication with the upstream opening of the inlet channel of the downstream mixing section.

Aspect 4. The extruder mixer of any of Aspects 1-3, comprising a blister, wherein the blister is arranged between the downstream opening of the outlet channel of the upstream mixing and the upstream opening of the inlet channel of the downstream mixing section, wherein the blister is constructed and arranged such that a flow of plasticized flowable material over the blister provides a vacuum seal between the two mixing sections.

Aspect 5. The extruder mixer of any of Aspects 1-4, the direction of the inlet channel being oriented at an angle of 30 to 60 degrees relative to the central axis of the elongated rotational screw.

Aspect 6. The extruder mixer of any of Aspects 1-5, the direction of the inlet channel being oriented at an angle of 40 to 50 degrees relative to the central axis of the elongated rotational screw.

Aspect 7. The extruder mixer of any of Aspects 1-6, the first pump being arranged at an angle of 30 to 60 degrees relative to the direction of the inlet channel.

Aspect 8. The extruder mixer of any of Aspects 1-7, further comprising a fluid insertion aperture located in the outlet channel, the fluid insertion aperture being configured and arranged to be in fluid connection with a fluid delivery passage within the elongated rotatable screw.

Aspect 9. The extruder mixer of any of Aspects 1-8, further comprising a blister in at least one of the inlet channels of the at least one mixing section.

Aspect 10. An extruder screw comprising the extruder mixer of any of Aspects 1-9.

Aspect 11. The extruder screw of Aspect 10, further comprising a flighted section upstream of the at least one mixing section, wherein the flighted section is configured and arranged to control a flow of plasticized flowable material into the upstream opening of the inlet channel of the at least one mixing section.

Aspect 12. The extruder screw of Aspect 10 or Aspect 11, further comprising a flighted section between the upstream mixing section of the at least two mixing sections and the downstream mixing section of the at least two mixing sections, wherein the flighted section is configured and arranged to control a flow of plasticized flowable material into the upstream opening of the inlet channel of the downstream mixing section.

Aspect 13. The extruder screw of any of Aspects 10-12, further comprising at least one barrier flight, wherein the at least two mixing sections are downstream of the at least one barrier flight.

Aspect 14. An extruder system comprising:
an extruder barrel having a bore extending along a central axis;
a polymer feeder associated with the extruder barrel and configured to feed polymer into the bore of the extruder barrel;
an elongated rotatable screw extending within the bore of the extruder barrel and mounted for rotation about the central axis of the extruder barrel; and
at least one extruder mixer of any of Aspects 1-9 provided on the elongated rotatable screw and configured to mix the polymer fed into the bore of the extruder barrel.

Aspect 15. A method for mixing at least one polymer in an extruder system having an extruder barrel having a bore extending along a central axis, the method comprising:
feeding the at least one polymer into the bore of the extruder barrel from a polymer feeder;
rotating an extruder screw extending within the bore of the extruder barrel about the central axis of the extruder barrel; and
mixing the at least one polymer fed into the bore of the extruder barrel by
   flowing the at least one polymer into an inlet channel of a mixing section of the extruder screw in a direction angled relative to the central axis of the extruder screw from an upstream opening of the inlet channel to a downstream side of the inlet channel,
   pumping the at least one polymer from the downstream side of the inlet channel to an upstream side of an intermediate channel using a first pump,
   flowing the at least one polymer from the upstream side of the intermediate channel to a downstream side of the intermediate channel,
   pumping the at least one polymer from the downstream side of the intermediate channel to an upstream side of an outlet channel using a second pump,
   flowing the at least one polymer from the upstream side of the outlet channel to a downstream opening of the outlet channel, and
   guiding the at least one polymer along the outlet channel using a downstream flight portion;
thereby producing an extruded mixture of the at least one polymer.

Aspect 16. The method of Aspect 15, wherein the feeding is starve feeding.

Aspect 17. The method of either Aspect 15 or Aspect 16, further comprising, after guiding the at least one polymer along the outlet channel using a downstream flight portion, a step of inhibiting flow of the at least one polymer from downstream ends of the inlet channel and the intermediate channel using a transverse flight portion oriented transverse relative to the downstream flight portion.

Aspect 18. The method of any of Aspects 15-17, wherein the polymer comprises at least two polymers.

Aspect 19. The method of any of Aspects 15-18, further comprising feeding at least one additive into the bore of the extruder.

Aspect 20. The method of any of Aspects 15-19, further comprising venting the mixing section.

Aspect 21. A method for reducing hygroscopic properties of a hygroscopic polymer in an extruder system having an extruder barrel with a bore extending along a central axis, the method comprising:
drying wet hygroscopic polymer to produce a dried hygroscopic polymer;
feeding the dried hygroscopic polymer into the bore of the extruder barrel from a polymer feeder;
rotating an extruder screw extending within the bore of the extruder barrel about the central axis of the extruder barrel; and
mixing the dried hygroscopic polymer fed into the bore of the extruder barrel by
   flowing the polymer into an inlet channel of a mixing section of the extruder screw in a direction angled relative to the central axis of the extruder screw from an upstream opening of the inlet channel to a downstream side of the inlet channel,
   pumping the polymer from the downstream side of the inlet channel to an upstream side of an intermediate channel using a first pump,
   flowing the polymer from the upstream side of the intermediate channel to a downstream side of the intermediate channel,
   pumping the polymer from the downstream side of the intermediate channel to an upstream side of an outlet channel using a second pump,
   flowing the polymer from the upstream side of the outlet channel to a downstream opening of the outlet channel, and
   guiding the polymer along the outlet channel using a downstream flight portion;
thereby producing an extruded polymer having reduced hygroscopic properties as compared to the dried hygroscopic polymer such that a water absorption rate of the extruded polymer is less than a water absorption rate of the dried hygroscopic polymer.

Aspect 22. The method of Aspect 21, wherein the feeding is starve feeding.

Aspect 23. The method of either Aspect 21 or 22, further comprising, after guiding the at least one polymer along the outlet channel using a downstream flight portion, a step of inhibiting flow of the polymer from downstream ends of the inlet channel and the intermediate channel using a transverse flight portion oriented transverse relative to the downstream flight portion.

Aspect 24. The method of any of Aspects 21-23, the feeding being performed while maintaining a pressure less than 75 psi.

Aspect 25. A method of inhibiting the formation of bubbles in extrudate of a hygroscopic polymer using an extruder system having an extruder barrel with a bore extending along a central axis, the method comprising:
feeding wet hygroscopic polymer into the bore of the extruder barrel from a polymer feeder;
rotating an extruder screw extending within the bore of the extruder barrel about the central axis of the extruder barrel; and
mixing the wet hygroscopic polymer fed into the bore of the extruder barrel by
   flowing the polymer into an inlet channel of a mixing section of the extruder screw in a direction angled relative to the central axis of the extruder screw from an upstream opening of the inlet channel to a downstream side of the inlet channel,
   pumping the polymer from the downstream side of the inlet channel to an upstream side of an intermediate channel using a first pump,
   flowing the polymer from the upstream side of the intermediate channel to a downstream side of the intermediate channel,
   pumping the polymer from the downstream side of the intermediate channel to an upstream side of an outlet channel using a second pump,
   flowing the polymer from the upstream side of the outlet channel to a downstream opening of the outlet channel, and
   guiding the polymer along the outlet channel using a downstream flight portion;
thereby producing the substantially bubble-free extrudate and eliminating the need to dry the hygroscopic polymer prior to extrusion.

Aspect 26. The method of Aspect 25, wherein the feeding is starve feeding.

Aspect 27. The method of either Aspect 25 or 26, further comprising, after guiding the at least one polymer along the outlet channel using a downstream flight portion, a step of inhibiting flow of the polymer from downstream ends of the inlet channel and the intermediate channel using a transverse flight portion oriented transverse relative to the downstream flight portion.

Aspect 28. The method of any of Aspects 25-27, the feeding being performed while maintaining a pressure less than 75 psi.

### EXAMPLES

### Example 1: Mixing Coffee Chaff into Polyethylene

Natural materials, such as coffee chaff, often contain water. Typically, the water is removed prior to processing or vented during extrusion. Coffee chaff also contains oil that is not removed by drying. Heated oils can become vaporous and during extrusion, these vapors must be removed by venting. The ability of one or more vents to remove either water or oily vapors is limited. If there is too much water or oil, the gases formed by heating the material to the polymer process conditions produce bubbles or expel the material uncontrollably.

LDPE: Undried coffee chaff was then mixed at 5 wt % with low density polyethylene (LDPE). A screw including the inventive extruder mixer section was used to process the LDPE/coffee chaff, using typical temperature profile for LDPE. The screw shown in FIG. 1 was then used to process the LDPE and 5% coffee under a flood fed condition. This provided a poorly mixed, foaming, strand. While the quality of the extrudate was poor, it should be noted that this result of producing a strand at all was surprising. A conventional screw would not provide a strand at all, due to the water pooling and causing breakage as the strand cools. Starve feeding the 5 wt % of the coffee chaff in LDPE with the FIG. 1 screw produced a smooth high quality extrudate with no melt fracture.

### Example 2: Undried Acrylic (Polymethylmethacrylate)

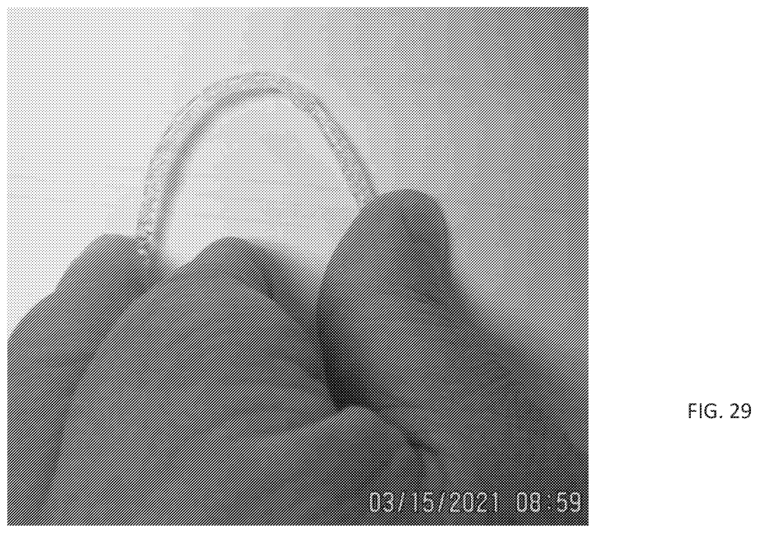

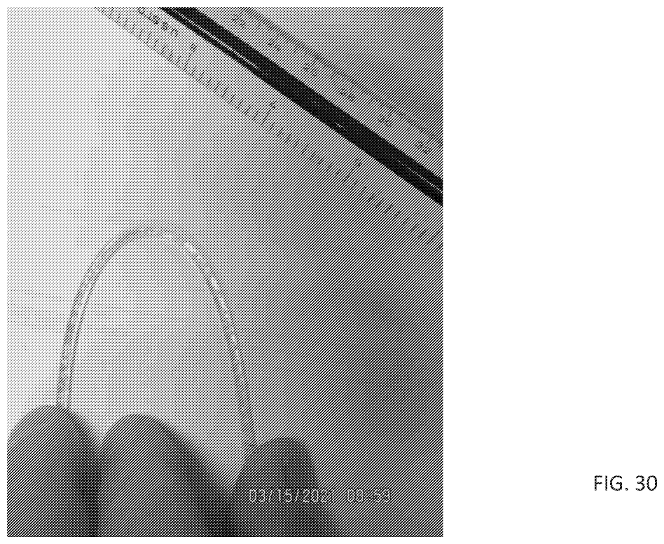

Acrylic is a hygroscopic material and therefore absorbs water vapor from the air. When the water “pools” from the collection of vapor into larger “puddles” (so to speak), these become significant and form large, visible bubbles that typically burst while extruding the material. A flood fed conventional extruder screw of undried material provided a bumpy poor quality extrudate, shown as the top strand of FIG. 25. The bottom strand photographed in FIG. 28 shows the wet PMMA extruded through a starve-fed FIG. 1 screw. This strand has a smooth surface and includes only vacuum bubbles caused by too-rapid cooling. The photos in FIGS. 29-31 show how the lower stand may be bent and even tied in knots.

### Example 3: Undried Polycarbonate

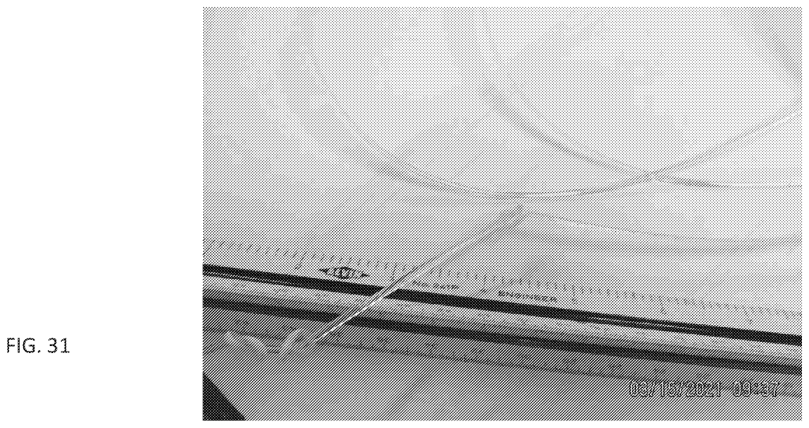

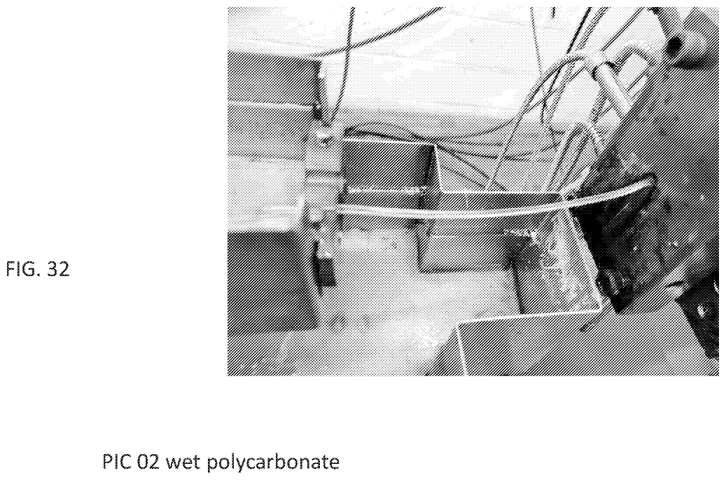

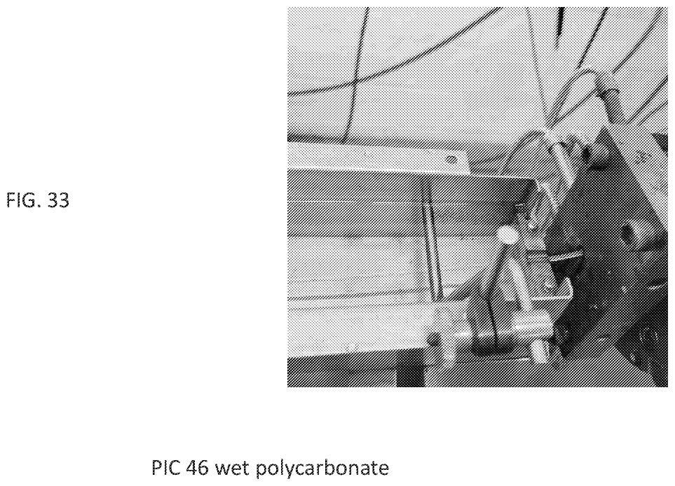

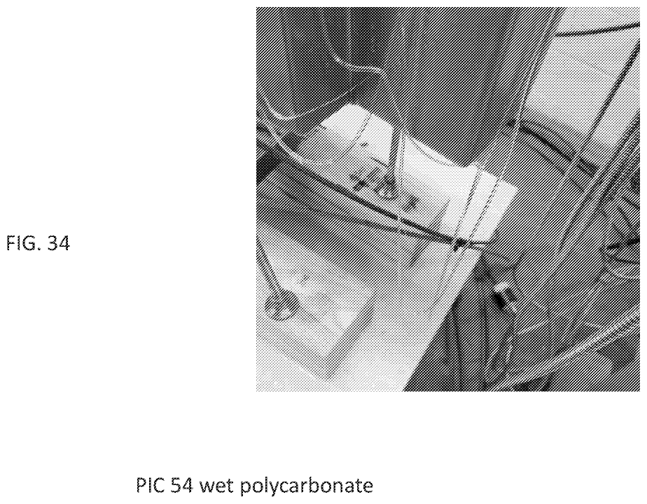

The photographs in FIGS. 32-34 show undried polycarbonate starve-fed extruded at the typical temperature profile for polycarbonate at various distance from the die. The screw used is the screw shown in FIG. 1. As may be seen in the photographs, the undried polycarbonate provided a smooth, bubble-free extrudate.

### Example 4: Undried PEEK (Polyetheretherketone)

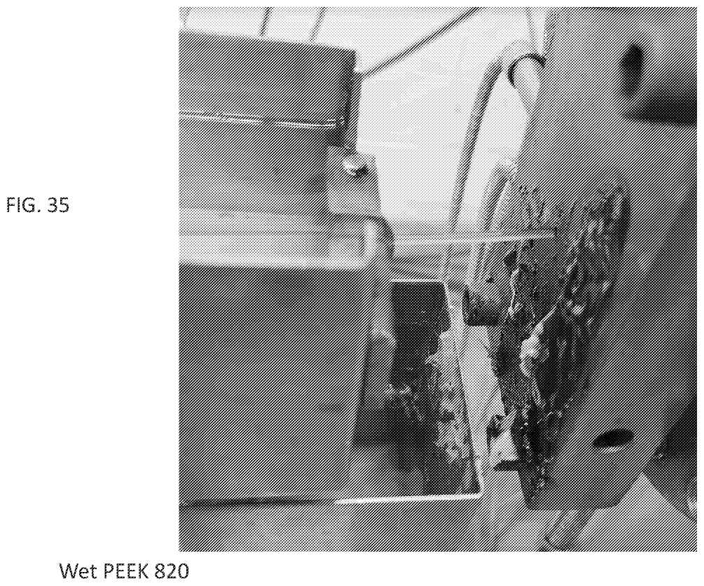

The photographs in FIG. 35 shows undried PEEK starve-fed extruded at the typical temperature profile for PEEK as it emerges from the die. The screw used is the screw shown in FIG. 1. As may be seen in the photographs, the undried PEEK provided a smooth, bubble-free extrudate.

### Example 5: Undried Titanium Dioxide Concentrate in San

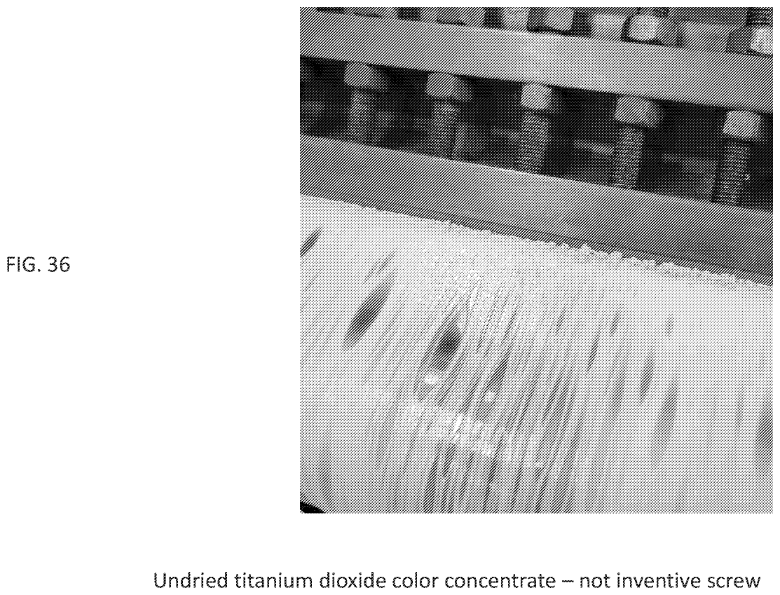

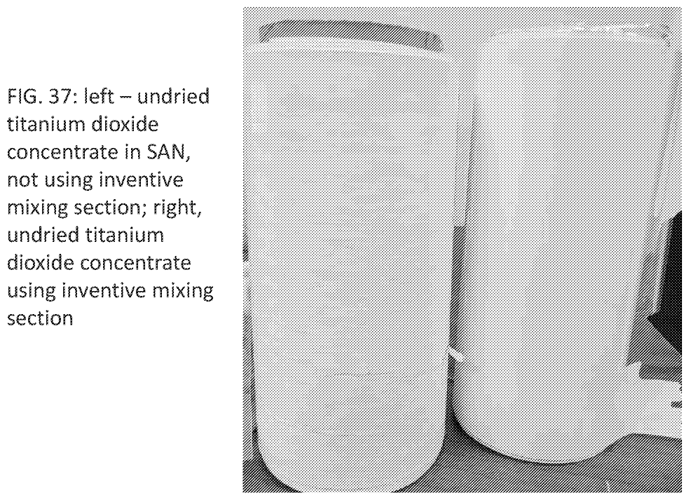

An undried concentrate of titanium dioxide in SAN (styrene acrylonitrile) was extruded through a conventional screw, through a film die using a typical temperature profile for SAN. The extrudate out of the film die is shown in FIG. 36. The film is bubbly and very poor quality. FIG. 37 shows on the left, film made from the undried concentrate of titanium dioxide in SAN using a conventional screw and on the right, a sample of film made from undried concentrate of titanium dioxide in SAN using a screw including the inventive mixing section. As is clear from the pictures, the film made using the inventive mixing section is smooth and of high quality, while the film made using the conventional screw is rough and has holes.

### Example 6: Undried Acrylic (Pmma)

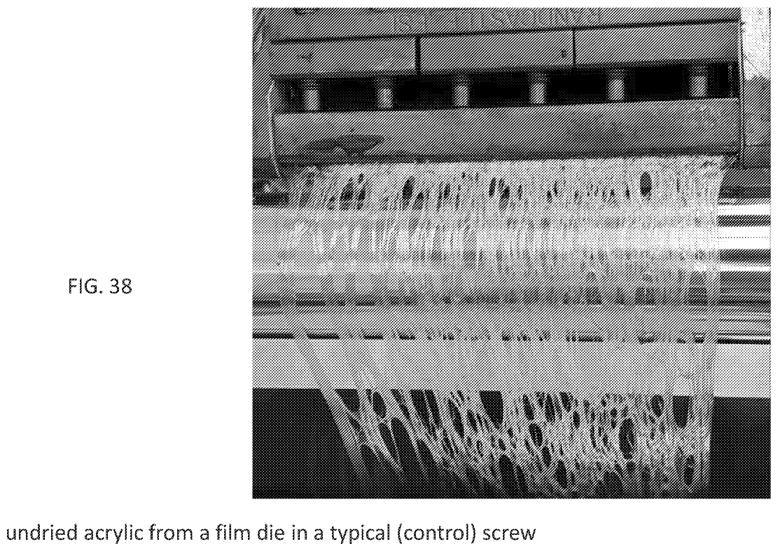

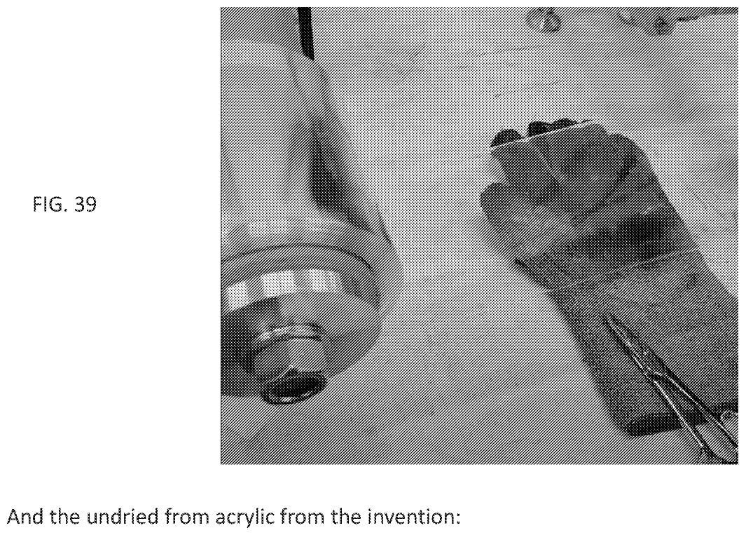

Undried PMMA was extruded through a conventional screw, through a film die using a typical temperature profile for PMMA. The extrudate out of the film die is shown in FIG. 38. The film is bubbly and very poor quality. In contrast, FIG. 39 shows the same undried acrylic material, starve-fed extruded through using the FIG. 1 screw using the same temperature profile. It can be seen that the film is of excellent quality with no bubbles or visible defects.

### Example 7: Undried Carbon Black Concentrate in San

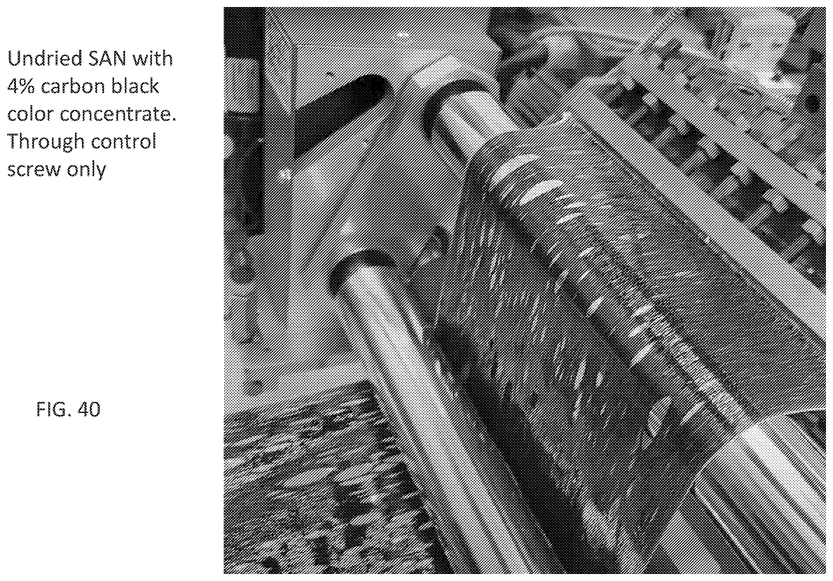

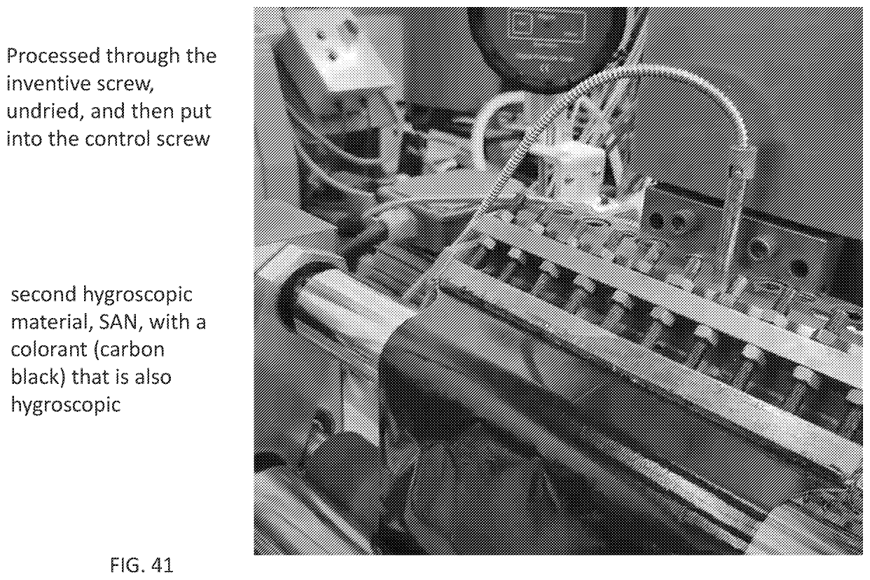

Undried carbon black concentrate in SAN was extruded through a conventional screw, through a film die using a typical temperature profile for SAN. The extrudate out of the film die is shown in FIG. 40. The film is bubbly and very poor quality. In contrast, FIG. 41 shows the same undried carbon black concentrate in SAN material, starve-fed extruded through using the FIG. 1 screw using the same temperature profile. It can be seen that the film is of excellent quality with no bubbles or visible defects.

### Example 8: Pelletized Dried Acrylic

Dried acrylic is pelletized using the screw shown in FIG. 1. Then, those pellets are extruded without drying, using a control screw (with the recommended processing parameters from the manufacturer). The moisture uptake of the pellets is measured over time. The pellets show a slower rate of moisture absorption compared to pellets not extruded using the FIG. 1 screw.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

1. An extruder mixer positioned about a central axis of an elongated rotatable screw, the extruder mixer comprising:
at least two mixing sections between upstream and downstream ends of the elongated rotatable screw, each of the at least two mixing sections having:
an inlet channel oriented in a direction angled relative to the central axis of the elongated rotatable screw, the inlet channel having an upstream opening, a downstream end, and a downstream side,
an intermediate channel circumferentially spaced from the inlet channel and oriented along the direction of the inlet channel, the intermediate channel having an upstream side, a downstream end, and a downstream side,
an outlet channel circumferentially spaced from the intermediate channel and oriented along the direction of the inlet channel, the outlet channel having an upstream side, a downstream side, and a downstream opening,
a first pump interposed between the downstream side of the inlet channel and the upstream side of the intermediate channel,
a second pump interposed between the downstream side of the intermediate channel and the upstream side of the outlet channel, and
a downstream flight portion positioned along the outlet channel;
wherein the inlet channel, the intermediate channel, the output channel, the first pump, the second pump, and the downstream flight portion are arranged as follows:
the inlet channel is bound at the downstream side by the first pump,
the first pump is bound at the upstream side by the inlet channel, and at the downstream side by the intermediate channel;
the intermediate channel is bound at the upstream side by the first pump, and at the downstream side by the second pump;
the second pump is bound at the upstream side by the intermediate channel, and at a downstream side by the outlet channel; and
the outlet channel is open at the downstream end and bound at a downstream side by the downstream flight portion and at the upstream side by the second pump;
wherein a height of the downstream flight portion is greater than heights of the first pump and the second pump in a direction radially outward from the central axis of the elongated rotational screw; and
wherein one of the at least two mixing sections is an upstream mixing section and another one of the at least two mixing sections is a downstream mixing section, and wherein the downstream opening of the outlet channel of the upstream mixing section is in flow communication with the upstream opening of the inlet channel of the downstream mixing section;
and comprising a transverse flight portion oriented transverse relative to the downstream flight portion of at least one of the at least two mixing sections, the transverse flight portion being positioned to terminate the respective downstream ends of the inlet channel of the at least one of the at least two mixing sections and the respective intermediate channel of the at least one of the at least two mixing sections, wherein:
the respective inlet channel of the at least one of the at least two mixing sections is bound at the respective downstream end by the transverse flight portion;
the respective first pump of the at least one of the at least two mixing sections is bound at the respective downstream end by the transverse flight portion;
the intermediate channel of the at least one of the at least two mixing sections is bound at the respective downstream end by the transverse flight portion; and
the respective second pump of the at least one of the at least two mixing sections is bound at the respective downstream end by the transverse flight portion;
and wherein a height of the transverse flight portion is greater than the heights of the first pump and the second pump of the at least one of the at least two mixing sections in a direction radially outward from the central axis of the elongated rotational screw.

2. (canceled)

3. The extruder mixer of claim 1, comprising a blister, wherein the blister is arranged between the downstream opening of the outlet channel of the upstream mixing and the upstream opening of the inlet channel of the downstream mixing section, wherein the blister is constructed and arranged such that a flow of plasticized flowable material over the blister provides a vacuum seal between the two mixing sections.

4. The extruder mixer of claim 1, the direction of the inlet channel being oriented at an angle of 30 to 60 degrees relative to the central axis of the elongated rotational screw.

5. The extruder mixer of claim 1, the direction of the inlet channel being oriented at an angle of 40 to 50 degrees relative to the central axis of the elongated rotational screw.

6. The extruder mixer of claim 1, the first pump being arranged at an angle of 30 to 60 degrees relative to the direction of the inlet channel.

7. The extruder mixer of claim 1, further comprising a fluid insertion aperture located in the outlet channel, the fluid insertion aperture being configured and arranged to be in fluid connection with a fluid delivery passage within the elongated rotatable screw.

8. The extruder mixer of claim 1, further comprising a blister in at least one of the inlet channels of the at least two mixing sections.

9. An extruder screw comprising the extruder mixer of claim 1.

10. The extruder screw of claim 9, further comprising a flighted section upstream of the at least one mixing section, wherein the flighted section is configured and arranged to control a flow of plasticized flowable material into the upstream opening of the inlet channel of the at least one mixing section.

11. (canceled)

12. The extruder screw of claim 9, further comprising a flighted section between the upstream mixing section of the at least two mixing sections and the downstream mixing section of the at least two mixing sections, wherein the flighted section is configured and arranged to control a flow of plasticized flowable material into the upstream opening of the inlet channel of the downstream mixing section.

13. The extruder screw of claim 9, further comprising at least one barrier flight, wherein the at least two mixing sections are downstream of the at least one barrier flight.

14. An extruder system comprising:
an extruder barrel having a bore extending along a central axis;
a polymer feeder associated with the extruder barrel and configured to feed polymer into the bore of the extruder barrel;
an elongated rotatable screw extending within the bore of the extruder barrel and mounted for rotation about the central axis of the extruder barrel; and
at least one extruder mixer of claim 1 provided on the elongated rotatable screw and configured to mix the polymer fed into the bore of the extruder barrel.

15. A method for mixing at least one polymer in an extruder system having an extruder barrel having a bore extending along a central axis, the method comprising:
starve feeding the at least one polymer into the bore of the extruder barrel from a polymer feeder;
rotating an extruder screw extending within the bore of the extruder barrel about the central axis of the extruder barrel; and
mixing the at least one polymer fed into the bore of the extruder barrel by flowing the at least one polymer into an inlet channel of a mixing section of the extruder screw in a direction angled relative to the central axis of the extruder screw from an upstream opening of the inlet channel to a downstream side of the inlet channel,
pumping the at least one polymer from the downstream side of the inlet channel to an upstream side of an intermediate channel using a first pump,
flowing the at least one polymer from the upstream side of the intermediate channel to a downstream side of the intermediate channel,
pumping the at least one polymer from the downstream side of the intermediate channel to an upstream side of an outlet channel using a second pump,
flowing the at least one polymer from the upstream side of the outlet channel to a downstream opening of the outlet channel, and
guiding the at least one polymer along the outlet channel using a downstream flight portion;
thereby producing an extruded mixture of the at least one polymer.

16. (canceled)

17. The method of claim 15, further comprising, after guiding the at least one polymer along the outlet channel using a downstream flight portion, a step of inhibiting flow of the at least one polymer from downstream ends of the inlet channel and the intermediate channel using a transverse flight portion oriented transverse relative to the downstream flight portion.

18. The method of claim 15, wherein the polymer comprises at least two polymers.

19. The method of claim 15, further comprising feeding at least one additive into the bore of the extruder.

20. The method of claim 15, further comprising venting the mixing section.

21. A method for reducing hygroscopic properties of a hygroscopic polymer in an extruder system having an extruder barrel with a bore extending along a central axis, the method comprising:
drying wet hygroscopic polymer to produce a dried hygroscopic polymer;
starve feeding the dried hygroscopic polymer into the bore of the extruder barrel from a polymer feeder;
rotating an extruder screw extending within the bore of the extruder barrel about the central axis of the extruder barrel; and
mixing the dried hygroscopic polymer fed into the bore of the extruder barrel by flowing the polymer into an inlet channel of a mixing section of the extruder screw in a direction angled relative to the central axis of the extruder screw from an upstream opening of the inlet channel to a downstream side of the inlet channel,
pumping the polymer from the downstream side of the inlet channel to an upstream side of an intermediate channel using a first pump,
flowing the polymer from the upstream side of the intermediate channel to a downstream side of the intermediate channel,
pumping the polymer from the downstream side of the intermediate channel to an upstream side of an outlet channel using a second pump,
flowing the polymer from the upstream side of the outlet channel to a downstream opening of the outlet channel, and
guiding the polymer along the outlet channel using a downstream flight portion;
thereby producing an extruded polymer having reduced hygroscopic properties as compared to the dried hygroscopic polymer such that a water absorption rate of the extruded polymer is less than a water absorption rate of the dried hygroscopic polymer.

22. (canceled)

23. The method of claim 21, further comprising, after guiding the at least one polymer along the outlet channel using a downstream flight portion, a step of inhibiting flow of the polymer from downstream ends of the inlet channel and the intermediate channel using a transverse flight portion oriented transverse relative to the downstream flight portion.

24. The method of claim 21, the feeding being performed while maintaining a pressure less than 75 psi.

25. A method of inhibiting the formation of bubbles in extrudate of a hygroscopic polymer using an extruder system having an extruder barrel with a bore extending along a central axis, the method comprising:
feeding wet hygroscopic polymer into the bore of the extruder barrel from a polymer feeder;
rotating an extruder screw extending within the bore of the extruder barrel about the central axis of the extruder barrel; and
mixing the wet hygroscopic polymer fed into the bore of the extruder barrel by flowing the polymer into an inlet channel of a mixing section of the extruder screw in a direction angled relative to the central axis of the extruder screw from an upstream opening of the inlet channel to a downstream side of the inlet channel,
pumping the polymer from the downstream side of the inlet channel to an upstream side of an intermediate channel using a first pump,
flowing the polymer from the upstream side of the intermediate channel to a downstream side of the intermediate channel,
pumping the polymer from the downstream side of the intermediate channel to an upstream side of an outlet channel using a second pump,
flowing the polymer from the upstream side of the outlet channel to a downstream opening of the outlet channel, and
guiding the polymer along the outlet channel using a downstream flight portion;
thereby producing the substantially bubble-free extrudate and eliminating the need to dry the hygroscopic polymer prior to extrusion.

26. The method of claim 25, wherein the feeding is starve feeding.

27. The method of claim 25, further comprising, after guiding the at least one polymer along the outlet channel using a downstream flight portion, a step of inhibiting flow of the polymer from downstream ends of the inlet channel and the intermediate channel using a transverse flight portion oriented transverse relative to the downstream flight portion.

28. The method of claim 25, the feeding being performed while maintaining a pressure less than 75 psi.
